(19) United States
(12) Patent Application Publication
(10) Pub. No.: US 2026/0104535 A1
(43) Pub. Date: Apr. 16, 2026

(54) ARTICLES WITH OPTICAL FILM STRUCTURES FOR PLANAR SUBSTRATES AND SUBSTRATES WITH NONPLANAR FEATURES, AND METHODS OF MAKING THE SAME

(71) Applicant: CORNING INCORPORATED, CORNING, NY (US)

(72) Inventors: Shandon Dee Hart, Elmira, NY (US); Carlo Anthony Kosik Williams, Painted Post, NY (US); Lin Lin, Painted Post, NY (US); Fred Douglas Woodall, II, Elmira, NY (US)

(21) Appl. No.: 19/332,534

(22) Filed: Sep. 18, 2025

Related U.S. Application Data
(60) Provisional application No. 63/707,038, filed on Oct. 14, 2024.

(51) Int. Cl. G02B 1/11; G02B 1/18

(52) U.S. Cl. CPC G02B 1/11; G02B 1/18

(57) ABSTRACT

An article is described herein that includes: a substrate comprising a first and second primary surface that oppose one another; and an optical film structure having an outer surface and a thickness of from about 200 nm to 900 nm, the optical film structure disposed on the first primary surface. The optical film structure includes at least one low refractive index (RI) layer comprising a refractive index from 1.35 to 1.54, at least one medium RI layer comprising a refractive index from 1.55 to 1.79, and at least one high RI layer comprising a refractive index of greater than 1.80. The article exhibits a first-surface average photopic reflectance of 2% or less, as measured from 0° to 10° incidence. Further, the article exhibits a first-surface reflectance of less than 3.5%, as measured at an infrared wavelength of 940 nm from 0° to 10° incidence.

### CLAIM OF PRIORITY

This application claims the benefit of priority under 35 U.S.C. § 119 of U.S. Provisional Application Ser. No. 63/707,038 filed on Oct. 14, 2024, the content of which is relied upon and incorporated herein by reference in its entirety.

### FIELD

This disclosure relates to articles (and methods of making them) for protection of optical articles and display devices, and particularly those that include a planar substrate or a substate with one or more primary surfaces with nonplanar features, and an optical film structure disposed thereon with at least one low index layer, at least one medium index layer, and at least one high index layer that exhibits various optical and mechanical performance attributes including, but not limited to, low in reflectance in the visible and infrared spectrum, low reflected color, color uniformity, minimized overall thickness, and high shallow hardness.

### BACKGROUND

Cover articles with substrates are often used to protect critical devices and components within electronic products and systems, such as mobile devices, smart phones, computer tablets, hand-held devices, vehicular displays and other electronic devices with displays, cameras, light sources and/or sensors. These cover articles can also be employed in architectural articles, transportation articles (e.g., articles used in automotive applications, trains, aircraft, sea craft, etc.), appliance articles, or any article that requires some transparency, scratch resistance, abrasion resistance, or a combination thereof.

These applications that employ cover articles often demand a combination of mechanical and environmental durability, breakage resistance, damage resistance, scratch resistance, and strong optical performance characteristics. For example, the cover articles may be required to exhibit high light transmittance, low reflectance and/or low transmitted color in the visible spectrum. For certain smartphone, smartwatch, laptop and tablet applications, the cover articles can be thin and/or exhibit these optical properties in the infrared spectrum. In some applications, the cover articles should cover and protect display devices, cameras, sensors and/or light sources.

Further, some of these cover article applications employ substrates with primary surfaces with one or more nonplanar features that can benefit from optical film structures that possess well-controlled reflectance and color. The optical film structures used for these cover articles can experience vacuum coating deposition-related line-of-sight effects that can reduce or vary the thickness of the layers that make up the film structure (i.e., thickness scaling) in the regions of the substrates that are not angled in the direction of maximum coating deposition rate. Further, the variable thickness of the layers of the optical film structures associated with these line-of-sight deposition effects can lead to optical properties (e.g., reflected color, reflectance, transmittance, and color shift) that undesirably vary as a function of the thickness variability of the layers within the optical film structure and/or the total thickness of the optical film structure.

Accordingly, there is a need for improved cover articles for protection of optical articles and devices, particularly those that include a planar substrate or a substate with one or more nonplanar features, and an optical film structure disposed thereon with at least one low index layer, at least one medium index layer, and at least one high index layer that exhibits various optical and mechanical performance attributes including, but not limited to, low in reflectance in the visible and infrared spectrum, low reflected color, color uniformity, minimized overall thickness, and high shallow hardness. This need and other needs are addressed by the present disclosure.

### SUMMARY

According to an aspect of the disclosure, an article is provided that includes: a substrate comprising a first primary surface and a second primary surface, the first and second primary surfaces opposing one another; and an optical film structure having an outer surface and a physical thickness of from about 200 nm to 900 nm, the optical film structure disposed on the first primary surface. The optical film structure comprises at least one low refractive index (RI) layer, at least one medium RI layer, and at least one high RI layer. The at least one medium RI layer comprises a refractive index from 1.55 to 1.79, the at least one high RI layer comprises a refractive index of greater than 1.80, and the at least one low RI layer comprises a refractive index from 1.35 to 1.54. The article exhibits a first-surface average photopic reflectance of 2% or less, as measured from 0° to 10° incidence. Further, the article exhibits a first-surface reflectance of less than 3.5%, as measured at an infrared wavelength of 940 nm from 0° to 10° incidence.

According to an aspect of the disclosure, an article is provided that includes: a substrate comprising a first primary surface and a second primary surface, the first and second primary surfaces opposing one another, and the first primary surface comprising a planar portion and a nonplanar portion; and an optical film structure having an outer surface and a physical thickness of from about 200 nm to 900 nm, the optical film structure disposed on the first primary surface. The optical film structure comprises at least one low refractive index (RI) layer, at least one medium RI layer, and at least one high RI layer. The at least one medium RI layer comprises a refractive index from 1.55 to 1.79, the at least one high RI layer comprises a refractive index of greater than 1.80, and the at least one low RI layer comprises a refractive index from 1.35 to 1.54. The article exhibits a first-surface average photopic reflectance of less than 1.5% for all optical film structure thickness scaling factors from 70% to 100%, as measured from 0° to 10° incidence. Further, the article exhibits a color shift in first-surface reflectance, as given by √(a*²+b*²), of 10 or less for all optical film structure thickness scaling factors from 80% to 100%, as measured from 0° to 90° incidence.

According to an aspect of the disclosure, an article is provided that includes: a substrate comprising a first primary surface and a second primary surface, the first and second primary surfaces opposing one another, and the first primary surface comprising a planar portion and a nonplanar portion; and an optical film structure having an outer surface and a physical thickness of from about 200 nm to 900 nm, the optical film structure disposed on the first primary surface. The optical film structure comprises at least one low refractive index (RI) layer, at least one medium RI layer, and at least one high RI layer. The at least one medium RI layer comprises a refractive index from 1.55 to 1.79, the at least one high RI layer comprises a refractive index of greater than 1.80, and the at least one low RI layer comprises a refractive index from 1.35 to 1.54. Further, the outer structure comprises a capping layer, the capping layer a low RI layer having a thickness of at least 70 nm. In addition, the optical film structure comprises directly below the capping layer either a sequence of a high RI layer comprising SiNₓ, medium RI layer comprising SiOₓN_{y}, and high RI layer comprising SiNₓ or a sequence of a medium RI layer comprising SiOₓN_{y}, high RI layer comprising SiNₓ, and medium RI layer comprising SiOₓN_{y}.

According to other aspects of the disclosure, a display device is provided that includes one or more of the foregoing articles, with each article serving as a protective cover for the display device.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### BRIEF DESCRIPTION OF THE DRAWINGS

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments, wherein:

FIGS. 1A-1D are cross-sectional side views of an exemplary article and optical film structure arrangement (e.g., for an electronic device), according to one or more embodiments of the disclosure;

FIG. 2A is a plan view of an exemplary electronic device incorporating any of the articles disclosed herein;

FIG. 2B is a perspective view of the exemplary electronic device of FIG. 2A;

FIG. 2C is a perspective view of alternative embodiments of the electronic device of FIG. 2A with a substrate having one or more nonplanar features on a primary surface (2.5D) or a substrate having one or more nonplanar features on both of its primary surfaces (3D), according to embodiments of the disclosure;

FIG. 2D is a perspective, cross-sectional view of the electronic devices of FIG. 2C that includes a substrate having one or more nonplanar features on a primary surface (2.5D);

FIG. 2E is a perspective, cross-sectional view of the electronic devices of FIG. 2C that includes a substrate having one or more nonplanar features on both of its primary surfaces (3D);

FIGS. 3A and 3B are respectively plots of first-surface reflectance and two-surface transmittance vs. wavelength, as measured at a near-normal incident angle of 8° and 0°, respectively, for a conventional article comprising a prior art optical film structure;

FIG. 3C is a plot of single-sided, reflected color, as measured at incident angles from 0° to 90° and optical film structure scaling factors from 70% to 100%, for the conventional article of FIGS. 3A and 3B;

FIGS. 4A and 4B are respectively plots of first-surface reflectance and two-surface transmittance vs. wavelength, as measured at a near-normal incident angle of 8° and 0°, respectively, for an article configured according to the arrangement of FIG. 1A, according to one or more embodiments of the disclosure;

FIG. 4C is a plot of single-sided, reflected color, as measured at incident angles from 0° to 90° and optical film structure scaling factors from 70% to 100%, for the article of FIGS. 4A and 4B;

FIGS. 5A and 5B are respectively plots of first-surface reflectance and two-surface transmittance vs. wavelength, as measured at a near-normal incident angle of 8° and 0°, respectively, for an article configured according to the arrangement of FIG. 1B, according to one or more embodiments of the disclosure;

FIG. 5C is a plot of single-sided, reflected color, as measured at incident angles from 0° to 90° and optical film structure scaling factors from 70% to 100%, for the article of FIGS. 5A and 5B;

FIGS. 6A and 6B are respectively plots of first-surface reflectance and two-surface transmittance vs. wavelength, as measured at a near-normal incident angle of 8° and 0°, respectively, for an article configured according to the arrangement of FIG. 1C, according to one or more embodiments of the disclosure;

FIG. 6C is a plot of single-sided, reflected color, as measured at incident angles from 0° to 90° and optical film structure scaling factors from 70% to 100%, for the article of FIGS. 6A and 6B;

FIGS. 7A and 7B are respectively plots of first-surface reflectance and two-surface transmittance vs. wavelength, as measured at a near-normal incident angle of 8° and 0°, respectively, for an article configured according to the arrangement of FIG. 1D, according to one or more embodiments of the disclosure; and

FIG. 7C is a plot of single-sided, reflected color, as measured at incident angles from 0° to 90° and optical film structure scaling factors from 70% to 100%, for the article of FIGS. 7A and 7B.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, and the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between material and the surface. The intervening material(s) may constitute a layer, as defined herein.

As used herein, the terms “low RI layer”, “medium RI layer” and “high RI layer” refer to the relative values of the refractive index (“RI”) of layers of an optical film structure of a transparent article according to the disclosure. Hence, the RI of the low RI layer<the RI of the medium RI layer<the RI of the high RI layer, unless otherwise expressly noted in this disclosure. Accordingly, low RI layers have refractive index values that are less than the refractive index values of medium and high RI layers. Further, as used herein, “low RI layer” and “low index layer” are interchangeable with the same meaning. Likewise, “medium RI layer” and “medium index layer” are interchangeable with the same meaning. Similarly, “high RI layer” and “high index layer” are interchangeable with the same meaning.

As used herein, the term “strengthened substrate” refers to a substrate employed in an article of the disclosure that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

As used herein the term “substrate” refers to a group of substrate materials that are inclusive of glass substrates, glass-ceramic substrates, substrates comprising a crystalline material, and strengthened substrates made of glass, glass-ceramic or crystalline materials. As used herein, the term “2.5D substrate” refers to a substrate with comprising a primary surface with a planar portion and at least one nonplanar portion or feature. As used herein, the term “3D substrate” refers to a substrate comprising two opposing primary surfaces, each primary surface having at least one nonplanar portion or feature.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of a single optical film structure or the outer optical film structure of an article of the disclosure with the diamond Berkovich indenter to form an indent to an indentation depth in the range from about 50 nm to about 900 nm (or the entire thickness of the outer or inner optical film structure, whichever is less) and measuring the maximum hardness from this indentation along the entire indentation depth range or a segment of this indentation depth (e.g., in the range from about 100 nm to about 600 nm), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximum hardness” interchangeably refers to a maximum hardness as measured along a range of indentation depths, and not an average hardness.

As used herein, the term “transmittance” is defined as the percentage of incident optical power within a given wavelength range transmitted through a material (e.g., the article, the substrate, the optical film structure, or portions or layer(s) thereof). The term “reflectance” is similarly defined as the percentage of incident optical power within a given wavelength range that is reflected from a material (e.g., the article, the substrate, the optical film structure, or portions or layer(s) thereof). Transmittance and reflectance are measured using a specific linewidth. As used herein, an “average transmittance” refers to the average amount of incident optical power transmitted through a material over a defined wavelength regime. As used herein, an “average reflectance” refers to the average amount of incident optical power reflected by the material. Further, unless otherwise noted, all transmittance data reported in the disclosure are associated with measuring an article comprising a substrate having a refractive index of ˜1.5 with two opposing primary surfaces and an optical film structure disposed on one of the primary surfaces, the other primary surface being bare. Consequently, the maximum possible transmittance is ˜96% for such articles as the bare primary surface exhibits ˜4% reflectance. Note, however, that if the substrate has a higher refractive index value as comprising a glass-ceramic, ceramic or crystalline material, the reflectance will be >4% for the bare primary surface and the maximum transmittance will be <96%, accordingly.

As used herein, “photopic reflectance” mimics the response of the human eye by weighting the reflectance or transmittance, respectively, versus wavelength spectrum according to the human eye's sensitivity. Photopic reflectance may also be defined as the luminance, or tristimulus Y value of reflected light, according to known conventions such as CIE color space conventions. The “average photopic reflectance”, as used herein, for a wavelength range from 380 nm to 720 nm is defined in the below equation as the spectral reflectance, R(λ) multiplied by the illuminant spectrum, I(λ) and the CIE's color matching function y̅(λ), related to the eye's spectral response:

$$〈 {R}_{p} 〉 = {\int }_{380 nm}^{720 nm} R ( λ ) \times I ( λ ) \times \overline{y} ( λ ) d λ$$

In addition, “average reflectance” can be determined over the visible spectrum, or over other wavelength ranges, according to measurement principles understood by those skilled in the field of the disclosure, e.g., in the infrared spectrum from 840 nm to 950 nm, etc. Unless otherwise noted, all reflectance values reported or otherwise referenced in this disclosure are associated with testing through both primary surfaces of the substrate and optical film structure(s) of the articles of the disclosure, e.g., a “two-surface” average photopic reflectance. In cases where “one-surface” or “first-surface” reflectance is specified, the reflectance from the rear surface of the article is eliminated through optical bonding to a light absorber, allowing the reflectance of only the first surface to be measured.

The usability of an article in an electronic device (e.g., as a protective cover) can be related to the total amount of reflectance in the article. Photopic reflectance is particularly important for display devices that employ visible light. Lower reflectance in a cover transparent article over a lens and/or a display associated with the device can reduce multiple-bounce reflections in the device that can generate ‘ghost images’. Thus, reflectance has an important relationship to image quality associated with the device, particularly its display and any of its other optical components (e.g., a lens of a camera). Low-reflectance displays also enable better display readability, reduced eye strain, and faster user response time (e.g., in an automotive display, where display readability can also correlate to driver safety). Low-reflectance displays can also allow for reduced display energy consumption and increased device battery life, since the display brightness can be reduced for low-reflectance displays compared to standard displays, while still maintaining the targeted level of display readability in bright ambient environments.

As used herein, “photopic transmittance” is defined in the below equation as the spectral transmittance, T(λ) multiplied by the illuminant spectrum, I(λ) and the CIE's color matching function y̅(λ), related to the eye's spectral response:

$$〈 {T}_{p} 〉 = {\int }_{380 nm}^{720 nm} T ( λ ) \times I ( λ ) \times \overline{y} ( λ ) d λ$$

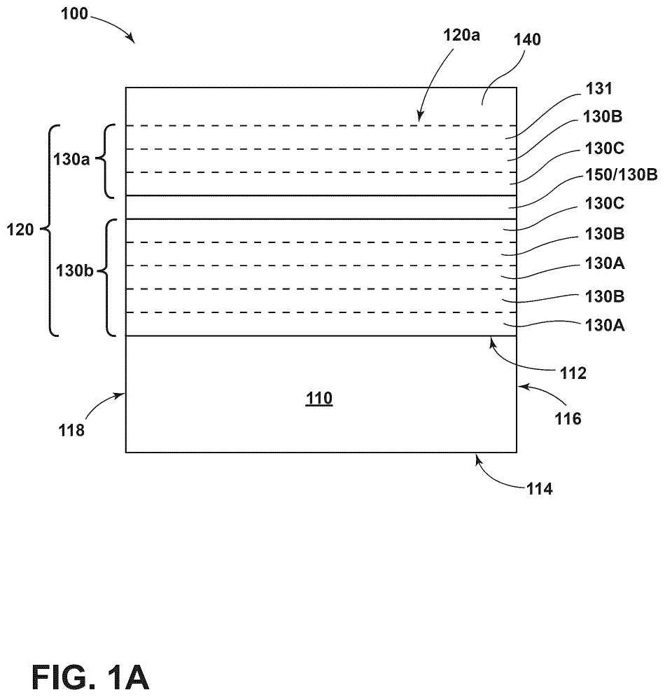

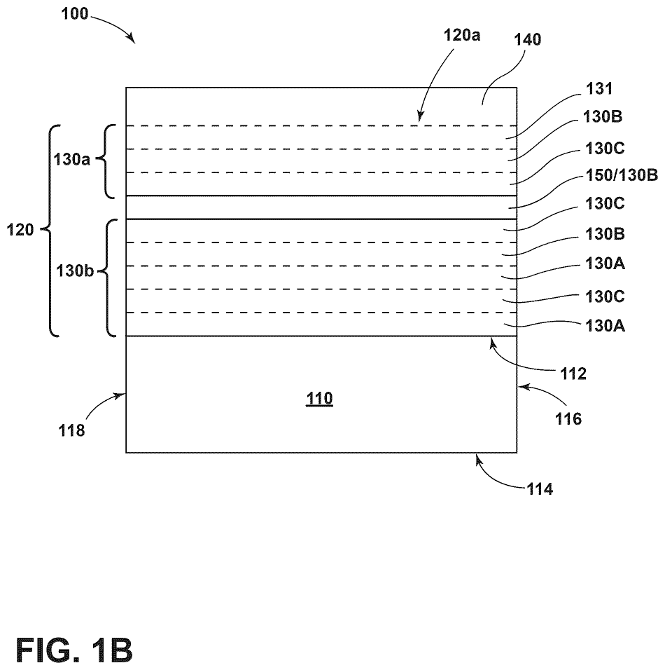

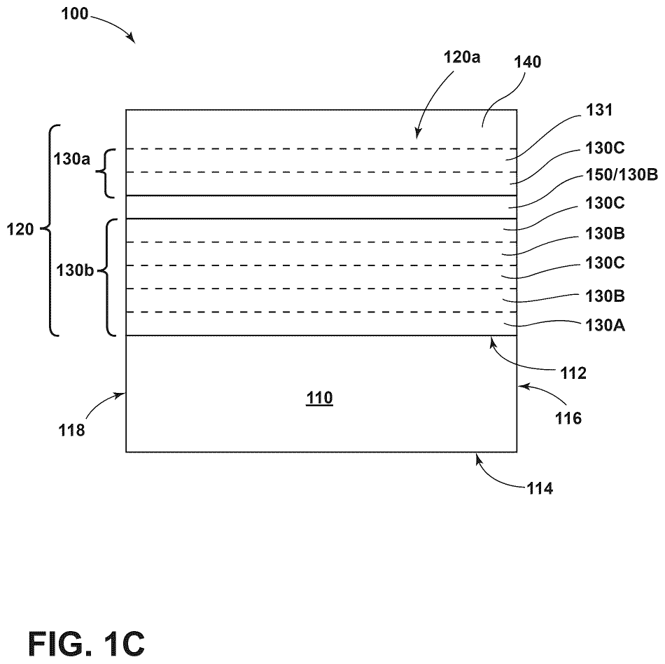

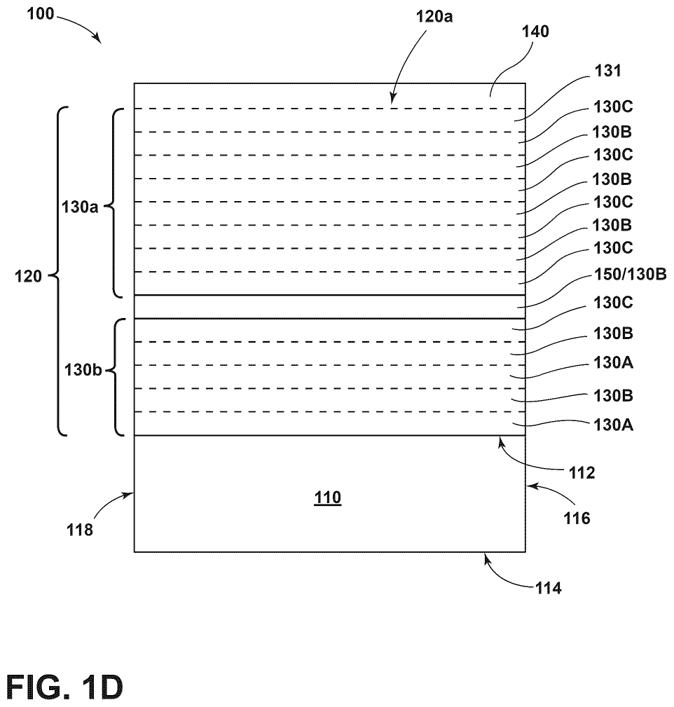

In addition, “average transmittance” or “average photopic transmittance” can be determined over the visible spectrum or other wavelength ranges, according to measurement principles understood by those skilled in the field of the disclosure. Unless otherwise noted, all transmittance values reported or otherwise referenced in this disclosure and claims are associated with testing through both primary surfaces of the substrate and the optical film structure (e.g., the substrate 110, primary surfaces 112, 114, and optical film structure 120 as shown in FIG. 1 and described below) of the articles, e.g., a “two-surface” average photopic transmittance.

As used herein, “transmitted color” and “reflected color” refer to the color transmitted or reflected through the articles of the disclosure with regard to color in the CIE L*, a*, b* colorimetry system under a D65 illuminant. More specifically, the “color shift” (i.e., as measured in transmission or reflectance) is given by √(a*²+b*²), as these color coordinates are measured through transmission or reflectance of a D65 illuminant through the primary surfaces of the substrate of the article (e.g., the substrate 110, primary surfaces 112, 114, and optical film structure 120 as shown in FIGS. 1A-ID and described below) over an incident angle range, e.g., from 0 degrees to 10 degrees.

As also used herein, an “optical film structure thickness scaling factor” and “thickness scaling factor” are interchangeable and generally refer to expected differences in the thickness of the optical film structures of the disclosure that can occur from vapor deposition of the optical film structure on a non-planar substrate or non-planar portions of a substrate. These optical film structure thickness differences as a function of methods employed to deposit these structures on substrates are detailed in following co-assigned: (1) U.S. Pat. No. 10,802,179 B2; (2) U.S. Pat. No. 11,500,130 B2; and (3) U.S. Patent Publication No. 2023/0273345, the salient portions of which are related to thickness scaling factors and similar concepts are hereby incorporated by reference in this disclosure. In turn, these variances in the thickness of the optical film structure may result in non-uniformity of transmitted and/or reflected color exhibited by the transparent articles of the disclosure possessing such optical film structures. As such, transmitted and reflected color values are reported in this disclosure for various thickness scaling factors such that “100%” corresponds to color measurements on an optical film structure on a planar surface of the substrate or at the maximum thickness of the optical film structure on a surface of the substrate, “90%” corresponds to the color measurements on an optical film structure on a non-planar surface having 90% of the thickness of the portion of the optical film structure on an adjacent planar surface or the portion of the optical film structure on a surface of the substrate having a maximum thickness, and so on.

Generally, the disclosure is directed to articles (and methods of making them) that employ optical film structures over substrates (e.g., comprising a glass, glass-ceramic or crystalline material), including strengthened substrates. These articles can include a high toughness, high modulus substrate that is optically transparent, with a high-hardness optical film structure having controlled transmittance and color. In view of this combination of substrate and optical film structure, the article can exhibit a high shallow hardness, while also exhibiting transparency, low reflectance, high visible and IR transmittance, and low color. Further, the articles of the disclosure can exhibit a low degree of reflectance variation in the visible spectrum and, accordingly, limited or no iridescence in reflectance.

Still further, the articles of the disclosure, as employing an optical film structure disposed on a substrate with one or more planar features (e.g., 2.5D and 3D substrates), can exhibit these mechanical and optical properties, including high color uniformity in reflectance. Although the optical film structures disposed on the 2.5D and 3D substrates may have coating thickness variability from deposition line-of-sight effects, the optical film structure configurations of the disclosure can ensure that the article-level optical properties do not degrade from any such film structure thickness variability. In embodiments, the thickness scaling performance on these 2.5D and 3D substrate can be achieved by increasing the bandwidth of the optical film structure so that as the film structure thickness is reduced in non-planar regions of the substrate, the low reflection portions of the spectrum still cover the visible range. Keeping the film structure thickness below certain target values can advantageously reduce film deposition cost and enable thinner device applications, along with enhanced article-level flexural strength performance. However, since reflectance and bandwidth of the optical film structures typically scale with the thickness and number of layers in the film structure, the optical film structures of the disclosure unexpectedly allow for thin overall thickness while exhibiting high hardness as well as the necessary bandwidth for the 2.5D and 3D substrates to exhibit uniform reflectance and color.

In addition, the optical film structures employed in the articles and applications of the disclosure can have a thickness that ranges from 200 to 900 nm, and at least one low refractive index (RI) layer, at least one medium RI layer, and at least one high RI layer. Further, these optical film structures can exhibit a maximum hardness of >8 GPa (>11 GPa for some embodiments), a total thickness of 900 nm or less (<500 nm for some embodiments), a photopic average reflectance of <1.5% for optical film structure thickness factors from 70 to 100% at 5° angle of incidence, a first-surface reflectance at a wavelength of 940 nm of <3.5%, and/or a two-surface transmittance at 940 nm of >92%.

In aspects of these articles, the optical film structures are configured such that the articles that employ them exhibit a hardness of at least about 10 GPa, at least about 11 GPa, at least about 12 GPa, or even at least about 13 GPa, at a Barkovich nanoindentation depth of about 100 nm from the outer surface of the optical film structure. The optical film structure may comprise a multilayer optical interference film composed of SiO₂, SiOₓ, SiOₓN_{y}, SiN_{y}, and/or Si₃N₄ layers, which can comprise a scratch-resistant layer (e.g., as embedded within the structure). According to some implementations, the optical film structure can comprise at least one low RI layer (e.g., SiO₂), at least one medium RI layer (e.g., SiOₓN_{y}), and at least one high RI layer (e.g., SiOₓ N_{y} or SiN_{y}). In an embodiment, the optical film structure comprises a scratch-resistant layer, an outer structure, and an inner structure, the scratch-resistant layer disposed between the outer and inner structures, the inner structure disposed on the first primary surface, the outer structure comprising at least one medium RI layer and at least one low RI layer, and the inner structure comprising at least one set of alternating high and low RI layers, and further wherein scratch-resistant layer is the thickest high index layer in the optical film structure. In an implementation, the outer structure of the optical film structure can comprise a capping layer, which is a low RI layer, having a thickness of at least 70 nm. In addition, the optical film structure (e.g., its outer structure) can comprise directly below the capping layer either a sequence of a high RI layer comprising SiNₓ, medium RI layer comprising SiOₓN_{y}, and high RI layer comprising SiNₓ, or a sequence of a medium RI layer comprising SiOₓN_{y}, high RI layer comprising SiNₓ, and medium RI layer comprising SiOₓN_{y}. Some or all these structural characteristics can enable or otherwise significantly influence the achievement of these shallow high hardness levels.

The articles of the disclosure can be employed for protection and/or covers of displays, camera lenses, sensors and/or light source components within or otherwise part of electronic devices, along with protection of other components (e.g., buttons, speakers, microphones, etc.). These articles with a protective function employ an optical film structure disposed on a substrate such that the article exhibits a combination of high shallow hardness and desirable optical properties. The optical film structure can include a scratch-resistant layer, at any of various locations within the structure. Further, the optical film structure includes at least one low RI layer, at least one medium RI layer, and at least one high RI layer. Advantageously, these shallow high hardness levels are exhibited by the articles of the disclosure without an appreciable loss in optical properties, e.g., low reflectance in the visible and IR spectra and low reflected color.

Also advantageously, the optical properties exhibited by the articles of the disclosure, including those associated with color uniformity, are inclusive of articles employing 2.5D and 3D substrates and any attendant variability in thickness of their optical film structures. As noted earlier, line-of-sight deposition effects can result in optical film structure thickness variability, particularly in regions of the substrate with nonplanar features. The inventive optical film structures, according to embodiments, are designed to compensate for this effect by maintaining uniform color and reflectance even for curved or faceted substrate regions where the optical film structure thickness may be reduced from its maximum value of 100%. Color uniformity for the inventive coating (color shift C*=√(a*²+b*²) less than 10, less than 8, less than 7, less than 6, or less than 5, considering all potential visible colors over all angles of incidence (AOI) from 0-90 degrees and over all flat and curved or angled regions of the substrate, for all optical film structure thickness scaling factors from 70-100%, 75-100%, 80-100%, 85-100%, 90-100%, and 95-100%. In addition, photopic average first-surface reflectance for the optical film structures for near-normal AOI of 0-10 degrees is maintained at less than 2%, less than 1.5%, less than 1.25%, less than 1.2%, less than 1.15%, less than 1.1%, or less than 1.05%.

As also outlined in the disclosure, the foregoing, advantageous article-level high shallow hardness levels can be achieved through the control of the composition and/or arrangement of the optical film structures employed in the articles. Notably, these hardness levels can be achieved by the articles of the disclosure while maintaining desired optical properties. In terms of optical properties, the articles of the disclosure can exhibit an average first-surface photopic reflectance of less than 2%, 1.75%, 1.5%, 1.25%, 1%, or even 0.9%, and a first-surface reflectance at a wavelength of 940 nm of less than 3.5%, 3.0%, 2.5%, 2%, 1.75%, or even 1.5%, all as measured at a near-normal angle of incidence (0-10°).

With regard to mechanical properties, embodiments of the articles of the disclosure can exhibit a maximum hardness of 9.5 GPa or greater, 10 GPa or greater, or 11 GPa or greater (or even greater than 12 GPa in some instances), as measured by a Berkovich Hardness Test over an indentation depth range from 100 nm to about 500 nm in the optical film structure.

According to some embodiments of the articles of the disclosure, advantageous article-level failure stress levels can be achieved through the control of the composition, arrangement and/or processing of the optical film structures employed in the articles. Notably, the composition, arrangement and/or processing of the optical film structures can be adjusted to obtain residual compressive stress levels of at least 400 MPa (e.g., from 400 to 1200 MPa) and an elastic modulus of at least 140 GPa (e.g., from 140 to 170 GPa, from 140 to 180 GPa, from 140 to 190 GPa, or from 140 to 200 GPa). These optical film structure mechanical properties correlate to average failure stress levels of 500 MPa or greater, 600 MPa or greater, or even 700 MPa or greater, in the articles employing these optical film structures, as measured in an ROR test with the outer surface of the optical film structure of the article placed in tension.

Referring to FIGS. 1A-1D, an article 100 according to one or more embodiments may include a substrate 110, and an optical film structure 120 defining an outer surface 120a and an inner surface 120b disposed on the substrate 110. The substrate 110 includes opposing primary surfaces 112, 114 and opposing secondary surfaces 116, 118. The optical film structure 120 is shown in FIGS. 1A-1D, with its inner surface 120b disposed on a first opposing primary surface 112 and no optical film structures are shown as being disposed on the second opposing primary surface 114. In some embodiments, however, one or more of the optical film structures 120 can be disposed on the second opposing primary surface 114 and/or on one or both opposing secondary surfaces 116, 118.

The optical film structure 120 generally includes at least three layers of material, e.g., at least one low RI layer 130A, at least one medium RI layer 130C, and at least one high RI layer 130B. As used herein, the term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments, a layer may include one or more contiguous and uninterrupted layers and/or one or more discontinuous and interrupted layers (i.e., a layer having different materials formed adjacent to one another). A layer or sub-layer may be formed by any known method in the art, including discrete deposition or continuous deposition processes. In one or more embodiments, the layer may be formed using only continuous deposition processes, or, alternatively, only discrete deposition processes.

In one or more embodiments, a single layer or multiple layers of the optical film structure 120 may be deposited onto a substrate 110 by a vacuum deposition technique such as, for example, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used such as spraying, dipping, spin coating, or slot coating (e.g., using sol-gel materials). Generally, vapor deposition techniques may include a variety of vacuum deposition methods which can be used to produce thin films. For example, physical vapor deposition uses a physical process (such as heating or sputtering) to produce a vapor of material, which is then deposited on the object which is coated. Preferred methods of fabricating the optical film structure 120 can include reactive sputtering, metal-mode reactive sputtering and PECVD processes.

The optical film structure 120 may have a physical thickness of from about 100 nm to about 1 micron. For example, the optical film structure 120 may have a thickness greater than or equal to about 100 nm, 200 nm, 300 nm, 325 nm, 350 nm, 375 nm, 400 nm, 500 nm, 600 nm, 700 nm, 800 nm, 900 nm, and less than or equal to about 1 micron. In some implementations of the articles 100 depicted in FIGS. 1A-1D, the optical film structure 120 has a physical thickness from 200 nm to 900 nm, 200 nm to 700 nm, 200 nm to 500 nm, 200 nm to 400 nm, or 500 nm to 800 nm, and all sub-ranges and thickness values between the foregoing ranges.

In some embodiments, as depicted for example in FIGS. 1A-ID, the optical film structure 120 is divided into an outer structure 130a and an inner structure 130b, with a scratch-resistant layer 150 (as detailed further below) disposed between the structures 130a and 130b. In these embodiments, the outer and inner optical film structures 130a and 130b may have the same thicknesses or different thicknesses, and each comprises one or more layers.

Referring again to the article 100 depicted in FIGS. 1A-ID, the optical film structure 120 includes one or more scratch-resistant layer(s) 150. For example, the article 100 depicted in FIGS. 1A-1D includes an optical film structure 120 with a scratch-resistant layer 150 disposed over a primary surface 112 of the substrate 110. According to one embodiment, the scratch-resistant layer 150 may comprise one or more materials chosen from SiᵤAlᵥOₓN_{y}, Ta₂O₅, Nb₂O₅, AlN, AlNₓ, SiAlₓN_{y}, AlNₓ/SiAlₓN_{y}, Si₃N₄, AlOₓN_{y}, SiOₓN_{y}, SiN_{y}, SiNₓ:Hy, HfO₂, TiO₂, ZrO₂, Y₂O₃, Al₂O₃, MoO₃, diamond-like carbon, or combinations thereof. Exemplary materials used in the scratch-resistant layer 150 may include an inorganic carbide, nitride, oxide, diamond-like material, or combinations thereof. Examples of suitable materials for the scratch-resistant layer 150 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer 150 may include Al₂O₃, AlN, AlOₓN_{y}, Si₃N₄, SiOₓ N_{y}, SiᵤAlᵥOₓN_{y}, diamond, diamond-like carbon, SiₓC_{y}, SiₓO_{y}C_{z}, ZrO₂, TiOₓN_{y}, and combinations thereof. In some implementations, the scratch-resistant layer 150 may include Si₃N₄, SiN_{y}, SiOₓN_{y}, and combinations thereof. In some embodiments, each of the scratch-resistant layers 150 employed in the article 100 may exhibit an effective fracture toughness value greater than about 1 MPa√m and simultaneously exhibits a hardness value greater than about 10 GPa, as measured by a Berkovich Hardness Test.

Each of the scratch-resistant layers 150, as shown in exemplary form in the article 100 depicted in FIGS. 1A-1D, can be comprised of any of the foregoing materials such that it exhibits a refractive index (RI) of greater than 1.80. In such implementations in which the RI of the scratch-resistant layer exceeds 1.80, the scratch-resistant layer 150 can be a high RI layer 130B (as depicted in FIGS. 1A-1D). In some implementations of the article 100, the RI of the scratch-resistant layer 150 is greater than 1.55, 1.60, 1.65, 1.80, 1.85, or greater than 1.90. For example, the RI of the scratch-resistant layer 150 can be 1.55, 1.60, 1.65, 1.70, 1.75, 1.80, 1.85, 1.9, 1.95, 2.0, 2.05, 2.10, 2.15, 2.20, 2.25, 2.3, 2.35, 2.4, 2.45, 2.5, and all RI values between the foregoing values.

Each of the scratch-resistant layers 150, as shown in exemplary form in the article 100 depicted in FIGS. 1A-1D, may be relatively thick as compared with other layers (e.g., low RI layers 130A, high RI layers 130B, medium RI layers 130C, capping layer 131, etc.) such as greater than or equal to about 25 nm, 35 nm, 38.1 nm, 45 nm, 50 nm, 75 nm, 80.4 nm, 100 nm, 102.9 nm, 150 nm, 163.8 nm, 200 nm, 250 nm, 300 nm, 325 nm, 350 nm, 375 nm, 400 nm, 425 nm, 450 nm, 475 nm, 500 nm, 525 nm, 550 nm, 575 nm, 600 nm, 700 nm, or even 750 nm. For example, a scratch-resistant layer 150 may have a thickness from about 25 nm to about 500 nm, from about 50 nm to about 500 nm, and all thickness levels and ranges between the foregoing ranges. In other implementations, the scratch-resistant layer 150 may have a thickness from about 25 nm to about 300 nm, from about 35 nm to about 300 nm, or from about 50 nm to about 250 nm.

As shown in FIGS. 1A-1D, and outlined above, the articles 100 of the disclosure include an optical film structure 120 with one or more of an outer structure 130a and inner structure 130b. The optical film structure 120 includes a scratch-resistant layer 150, at least one low RI layer 130A, at least one medium RI layer 130C, and at least one high RI layer 130B. In embodiments, the optical film structure 120 includes a plurality of alternating low RI and high RI layers, 130A and 130B, respectively. The outer structure 130a of the optical film structure 120 can includes one or more medium RI and high RI layers, 130C and 130B. In some embodiments, the inner structure 130b includes a plurality of alternating low RI and high RI layers, 130A and 130B, respectively. In some preferred implementations, the outer structure 130a includes at least one medium RI layer 130C in contact with the scratch-resistant layer 150. In some preferred implementations, the outer structure 130a is inclusive of at least one outermost capping layer 131 (e.g., with a refractive index within the range of those specified for low RI layers 130A).

According to some implementations, the optical film structure 120 can comprise at least one low RI layer 130a (e.g., SiO₂), at least one medium RI layer 130C (e.g., SiOₓN_{y}), and at least one high RI layer 130B (e.g., SiOₓN_{y} or SiN_{y}). In an embodiment, the optical film structure 120 comprises a scratch-resistant layer 150, an outer structure 130a, and an inner structure 130b, the scratch-resistant layer 150 disposed between the outer and inner structures 130a and 130b, respectively, the inner structure 130b disposed on the first primary surface 112, the outer structure 130a comprising at least one medium RI layer 130C and at least one low RI layer 130A, and the inner structure 130b comprising at least one set of alternating high and low RI layers 130B and 130A, respectively, and further wherein scratch-resistant layer 150 is the thickest high index layer in the optical film structure 120. In an implementation, the outer structure 130a of the optical film structure 120 can comprise a capping layer 131, which is a low RI layer (i.e., of the same material and refractive index of layer 130A), having a thickness of at least 70 nm. In addition, the optical film structure 120 (e.g., its outer structure 130a) can comprise directly below the capping layer 131 either a sequence of a high RI layer 130B comprising SiNₓ, medium RI layer 130C comprising SiOₓN_{y}, and high RI layer 130B comprising SiNₓ, or a sequence of a medium RI layer 130C comprising SiOₓN_{y}, high RI layer 130B comprising SiNₓ, and medium RI layer 130C comprising SiOₓN_{y}. Some or all these structural characteristics can enable or otherwise significantly influence the achievement of the foregoing mechanical and optical properties (e.g., shallow high hardness levels, color uniformity in reflectance and as a function of optical film structure thickness factors from 70-100%, etc.).

According to embodiments, each of the outer and inner structures 130a and 130b includes a period of two or more layers, including but not limited to the low RI layer 130A and high RI layer 130B; or a low RI layer 130A, high RI layer 130B and a low RI layer 130A; a high RI layer 130B and a medium RI layer 130C; or a medium RI layer 130C, high RI layer 130B and a medium RI layer 130C. Further, each of the outer and inner structures 130a and 130b of the optical film structure 120 may include a plurality of periods, such as 1 to 30 periods, 1 to 25 periods, 1 to 20 periods, and all periods within the foregoing ranges. In addition, the number of periods, the number of layers of the outer and inner structures 130a and 130b, and/or the number of layers within a given period can differ or they may be the same. Further, in some implementations, the total amount of low RI and high RI layers 130A and 130B and/or medium RI layers 130C and high RI layers 130B, along with the scratch-resistant layer 150, may range from 6 to 50 layers, 6 to 40 layers, 6 to 30 layers, 6 to 28 layers, 6 to 26 layers, 6 to 24 layers, 6 to 22 layers, 6 to 20 layers, 6 to 18 layers, 6 to 16 layers, and 6 to 14 layers, and all ranges of layers and amounts of layers between the foregoing values. In a preferred implementation, the total amount of the low RI, medium RI, and high RI layers 130A, 130C and 130B, respectively, along with the scratch-resistant layer 150 and capping layer 131, may range from 5 to 19 layers, 7 to 17 layers, or 8 to 14 layers (e.g., 8, 9, or 14 layers in total). Accordingly, the total number of layers of the optical film structure 120 of the article 100 depicted in FIGS. 1A-ID in exemplary form can be 5, 6, 7, 8, 9, 10, 11, 12, 13, 14, 15, 16, 17, 18, and 19 layers.

In an implementation of the article 100, as shown in FIG. 1A, the outer and inner structures 130a and 130b of the optical film structure 120 can be configured such that the outer structure 130a includes a total of three (3) alternating layers above the scratch-resistant layer 150: a medium RI layer 130C, a high RI layer 130B, and a capping layer 131; and the inner structure 130b includes a total of five (5) alternating layers above the substrate 110: a low RI layer 130A, a high RI layer 130B, a low RI layer 130A, a high RI layer 130B and a medium RI layer 130C. Accordingly, in the implementation depicted in exemplary form in FIG. 1A, the optical film structure 120 includes a total of 9 layers.

In an implementation of the article 100, as shown in FIG. 1B, the outer and inner structures 130a and 130b of the optical film structure 120 can be configured such that the outer structure 130a includes a total of three (3) alternating layers above the scratch-resistant layer 150: a medium RI layer 130C, a high RI layer 130B, and a capping layer 131; and the inner structure 130b includes a total of five (5) alternating layers above the substrate 110: a low RI layer 130A, a medium RI layer 130C, a low RI layer 130A, a high RI layer 130B and a medium RI layer 130C. Accordingly, in the implementation depicted in exemplary form in FIG. 1B, the optical film structure 120 includes a total of 9 layers.

In an implementation of the article 100, as shown in FIG. 1C, the outer and inner structures 130a and 130b of the optical film structure 120 can be configured such that the outer structure 130a includes a total of two (2) alternating layers above the scratch-resistant layer 150: a medium RI layer 130C, and a capping layer 131; and the inner structure 130b includes a total of five (5) alternating layers above the substrate 110: a low RI layer 130A, a high RI layer 130B, a medium RI layer 130C, a high RI layer 130B and a medium RI layer 130C. Accordingly, in the implementation depicted in exemplary form in FIG. 1C, the optical film structure 120 includes a total of 8 layers.

In an implementation of the article 100, as shown in FIG. 1D, the outer and inner structures 130a and 130b of the optical film structure 120 can be configured such that the outer structure 130a includes a total of eight (8) alternating layers above the scratch-resistant layer 150: a medium RI layer 130C, a high RI layer 130B, a medium RI layer 130C, a high RI layer 130B, a medium RI layer 130C, a high RI layer 130B, a medium RI layer 130C, and a capping layer 131; and the inner structure 130b includes a total of five (5) alternating layers above the substrate 110: a low RI layer 130A, a high RI layer 130B, a low RI layer 130A, a high RI layer 130B and a medium RI layer 130C. Accordingly, in the implementation depicted in exemplary form in FIG. 1D, the optical film structure 120 includes a total of 14 layers.

According to some embodiments of the article 100 depicted in FIGS. 1A-1D, the outermost capping layer 131 of the optical film structure 120 and outer structure 130a may not be exposed but instead have a top coating 140 disposed thereon. In some implementations of the article 100, each high RI layer 130B of the optical film structure 120, along with the outer and inner structures 130a, 130b, comprises a nitride, a silicon-containing nitride (e.g., SiN_{y}, Si₃N₄), an oxynitride, or a silicon-containing oxynitride (e.g., SiAlₓO_{y}N_{z} or SiOₓN_{y}). Further, according to some embodiments, each low RI layer 130A of the optical film structure 120, along with the outer and inner structures 130a, 130b, comprises an oxide, a silicon-containing oxide (e.g., SiO₂, SiOₓ or SiO₂ as doped with Al, N or F), or a silicon-containing oxynitride (e.g., SiOₓN_{y}). In addition, according to some embodiments, the scratch-resistant layer 150 and each medium RI layer 130C of the optical film structure 120 comprises an oxynitride or a silicon-containing oxynitride (e.g., SiAlₓO_{y}N_{z} or SiOₓN_{y}). In a preferred implementation of the article 100 depicted in FIG. 1, the outer structure 130a comprises a plurality of alternating high RI layers 130B of SiNₓ and medium RI layers 130C of SiOₓ N_{y} (along with an optional capping layer 131 of SiO₂ or SiOₓ N_{y}); and the inner structure 130b comprises a plurality of alternating high RI layers 130B of SiOₓN_{y} and low RI layers 130A of SiO₂.

In one or more embodiments of the article 100 depicted in FIGS. 1A-ID, the term “low RI”, when used with the low RI layers 130A and/or capping layer 131, includes a refractive index range of from about 1.35 to about 1.54, from about 1.4 to about 1.54, and all refractive indices within these ranges. In one or more embodiments, the term “medium RI”, when used with the medium RI layers 130C, includes a refractive index range from 1.55 to 1.79, 1.55 to 1.65, 1.6 to 1.79, 1.6 to 1.75, and all indices within these ranges. In one or more embodiments, the term “high RI”, when used with the high RI layers 130B and/or scratch-resistant layer 150, includes a refractive index range of greater than 1.80, greater than 1.90, from about 1.8 to about 2.5, from about 1.8 to about 2.3, from about 1.90 to about 2.5, and all indices between these ranges. Further, in a specific implementation, the medium RI layer(s) of the articles 100 of the disclosure, may include a refractive index range from 1.55 to 1.90, 1.55 to 1.85, 1.55 to 1.75, 1.55 to 1.65, and all values between these ranges. When two different medium-index materials are used in the same optical film structure 120 for medium RI layers 130C, these two medium index materials may have two refractive index values that differ by at least 0.05. For example, two medium index materials having refractive indices of 1.75 and 1.70 have a difference in refractive index of 0.05 and can each have a SiOₓN_{y} composition. In some embodiments, the optical film structure 120 can employ medium-index (n=1.5 to 1.9) SiOₓN_{y} layers 130C, along with at least one higher-index layer (n=1.9 or greater). This higher index layer 130B may be SiNₓ with an index from 2.0 to 2.07, or SiOₓN_{y} with index greater than 1.92. The optical film structure 120 may also comprise at least one lower index layer 130A with n<1.50, which may be SiO₂ having index 1.45-1.49.

In one or more embodiments, the difference in the refractive index of each of the low RI layers 130A (and/or capping layer 131), the medium RI layers 130C, and/or the high RI layers 130B (and/or scratch-resistant layer 150) may be about 0.01 or greater, about 0.05 or greater, about 0.1 or greater, or even about 0.2 or greater. In general, for a given embodiment, the definition of which layers in the optical film structure 120 are high RI, medium RI, and low RI will be defined by their relative values, that is, the RI value of the high RI layers 130B is greater than the RI value of the medium RI layers 130C, and the RI value of the medium RI layers 130C is greater than the RI value of the low RI layers 130A.

Example materials suitable for use in the outer and inner structures 130a and 130b of the optical film structure 120 of the article 100 depicted in FIGS. 1A-1D include, without limitation, SiO₂, SiOₓ, Al₂O₃, SiAlₓO_{y}, GeO₂, SiO, AlOₓN_{y}, AlN, AlNₓ, SiAlₓN_{y}, SiN_{y}, SiOₓ N_{y}, SiAlₓO_{y}N_{z}, Ta₂O₅, Nb₂O₅, TiO₂, ZrO₂, TIN, MgO, MgF₂, BaF₂, CaF₂, SnO₂, HfO₂, Y₂O₃, MoO₃, DyF₃, YbF₃, YF₃, CcF₃, diamond-like carbon and combinations thereof. Some examples of suitable materials for use in a low RI layer 130A and the outermost capping layer 131 include, without limitation, SiO₂, SiOₓ, Al₂O₃, SiAlₓO_{y}, GeO₂, SiO, AlOₓN_{y}, SiOₓ N_{y}, SiAlₓO_{y}N_{z}, MgO, MgAlₓO_{y}, MgF₂, BaF₂, CaF₂, DyF₃, YbF₃, YF₃, and CcF₃. In some implementations of the article 100, each of its low RI layers 130A includes a silicon-containing oxide (e.g., SiO₂ or SiOₓ) or a silicon-containing oxynitride (e.g., SiOₓN_{y}). The nitrogen content of the materials for use in a low RI layer 130A may be minimized (e.g., in materials such as SiOₓN_{y}, Al₂O₃ and MgAlₓO_{y}). Some examples of suitable materials for use in a high RI layer 130B include, without limitation, SiAlₓO_{y}N_{z}, Ta₂O₅, Nb₂O₅, AlN, AlNₓ, SiAlₓN_{y}, AlNₓ/SiAlₓN_{y}, Si₃N₄, AlOₓN_{y}, SiOₓ N_{y}, SiN_{y}, SiNₓ:Hy, HfO₂, TiO₂, ZrO₂, Y₂O₃, Al₂O₃, MoO₃, and diamond-like carbon. Some examples of suitable materials for use in a medium RI layer 130C include, without limitation, SiAlₓO_{y}N_{z}, AlOₓN_{y}, SiOₓ N_{y}, HfO₂, Y₂O₃, and Al₂O₃. According to some implementations, each high RI layer 130B of the outer and inner structures 130a, 130b includes a silicon-containing nitride or a silicon-containing oxynitride (e.g., Si₃N₄, SiN_{y}, or SiOₓN_{y}). In one or more embodiments, each of the high RI layers 130B may have high hardness (e.g., hardness of greater than 8 GPa), and the high RI materials listed above may comprise high hardness and/or scratch resistance.

The oxygen content of the materials for the high RI layer 130B may be minimized, especially in SiN_{y} materials. Further, exemplary SiOₓN_{y} high RI materials may comprise from about 0 atom % to about 20 atom % oxygen, or from about 5 atom % to about 15 atom % oxygen, while including 30 atom % to about 50 atom % nitrogen. The foregoing materials may be hydrogenated up to about 30% by weight. Where a material having a medium refractive index is desired as a medium RI layer 130C, some embodiments may utilize SiOₓN_{y}, e.g., with a relatively low level of nitrogen (e.g., less than 10%, less than 5%, or less than 3%). According to some embodiments, the scratch-resistant layer 150 of the articles 100 may comprise any of the materials disclosed as suitable for use in a high RI layer 130B or a medium RI layer 130C.

In one or more embodiments of the article 100 depicted in FIGS. 1A-ID, the optical film structure 120 includes a scratch-resistant layer 150 that can be integrated as a medium RI layer 130C, and one or more low RI layers 130A, high RI layers 130B, medium RI layers 130C, and/or a capping layer 131 may be positioned over the scratch-resistant layer 150. Also, as to the scratch-resistant layer 150, as shown in FIGS. 1A-1D, an optional top coating 140 may also be positioned over the layer 150. The scratch-resistant layer 150 may be alternately defined as the thickest medium RI layer 130C or high RI layer 130B in the overall optical film structure 120 and/or in the outer and the inner structures 130a, 130b.

Without being bound by theory, it is believed that the article 100 depicted in FIGS. 1A-1D may exhibit increased hardness at low indentation depths (e.g., 100-125 nm) when one or more medium RI layers 130C (e.g., as comprising SiOₓN_{y}) is placed in direct contact with one or more high RI layers 130B (e.g., SiOₓ N_{y}, SiN_{y}) in the outer structure 130a; the outer structure 130a is comprised of alternating layers of high RI layers 130B and medium RI layers 130C (which replaces alternating high RI layers 130B and low RI layers 130A in known optical film structures); the total thickness of the layers in the outer structure 130a is minimized; the thickness of the capping layer 131 is set at 70 nm or greater; and/or the outer structure 130a includes at least one medium RI layer 130C and at least one low RI layer 130A. In some implementations, it is believed that the article 100 depicted in FIGS. 1A-1D may exhibit increased hardness at low indentation depths (e.g., 100-125 nm) when the thickness of the capping layer is at least 70 nm and the outer structure 130a directly below the capping layer 131 has either a sequence of a high RI layer 130B, a medium RI layer 130C, and a high RI layer 130B or a sequence of a medium RI layer 130C, a high RI layer 130B, and a medium RI layer 130C. Further, according to some embodiments, a total thickness of all of the low RI layers 130A in the optical film structure 120 can be at least 80 nm, at least 90 nm, or even at least 100 nm, and/or at least 20%, 25%, or even 30% of the total thickness of the optical film structure 120.

Throughout the disclosure, “surface-modifying layer” refers to a layer that is characterized by changing a physical property or other behavior of the coated article. For example, a surface-modifying layer can modify one or more of a water contact angle, an oleic contact angle, a visibility of a fingerprint (e.g., simulated fingerprint), and/or an ability to remove a fingerprint (e.g., by wiping). In one or more embodiments, the article 100 depicted in FIGS. 1A-1D may include one or more additional top coatings 140 disposed on the outer structure 130a of the optical film structure 120. In one or more embodiments, the additional top coating 140 may include a surface modifying layer such as a fingerprint hiding coating, anti-fingerprint hiding layer or an easy-to-clean coating. Examples of a suitable anti-fingerprint hiding layer and easy-to-clean coatings are described in the following U.S. patent applications: U.S. Patent Application Publication No. 2014/0113083, published on Apr. 24, 2014, entitled “Process for Making of Glass Articles with Optical and Easy-to-Clean Coatings”; U.S. Provisional Patent Application No. 63/603,156, filed on Nov. 28, 2023, entitled “Coated Articles with a Surface-Modifying Layer and Methods of Making the Same”; U.S. Provisional Patent Application No. 63/546,775, filed on Nov. 1, 2023, entitled “Coated Articles with a Planarization Layer and a Surface-Modifying Layer and Methods of Making the Same”; and U.S. Non-Provisional patent application Ser. No. 18/528,916, filed on Dec. 5, 2023, entitled “Coated Articles with an Anti-Fingerprint Coating or Surface-Modifying Layer and Methods of Making the Same”, all of which are incorporated herein by reference in their entirety. The easy-to-clean coating can be a fluorine-containing material. Alternatively, the easy-to-clean coating (anti-fingerprint coating) can include a partial silica-like network having a ratio of Si—O—Si bonds to Si atoms in the coating from about 2 to about 3, the coating is fluorine-free, and the coating further comprises an alkyl silane at the exterior surface and bonded to Si—O groups in the anti-fingerprint coating. The easy-to-clean coating may have a thickness in the range from about 5 nm to about 50 nm and may include known materials such as fluorinated or non-fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating of the top coating 140 may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm, from about 7 nm to about 10 nm, from about 1 nm to about 90 nm, from about 5 nm to about 90 nm, from about 10 nm to about 90 nm, or from about 5 nm to about 100 nm, and all ranges and sub-ranges therebetween.

In aspects, the surface-modifying layer employed as the top coating 140 can be an anti-fingerprint coating. Throughout the disclosure, a surface-modifying layer is an “anti-fingerprint” coating if the coating on a glass-based substrate can reduce the visibility of, reduce a color shift of, and/or reduce droplet formation of fingerprint oil disposed thereon relative to the glass-based substrate without the coating. As used herein, the visibility of a fingerprint refers to an absolute value of a difference in brightness (e.g., CIELAB L* value) for a portion of the anti-fingerprint coating with the fingerprint oil and another portion of the anti-fingerprint coating without the fingerprint oil. As used herein, the color shift of the glass-based substrate refers to a difference in measured color as √((a₁*−a₂*)²+(b₁*−b₂*)²), where a* refers to CIELAB a* values, b* refers to CIELAB b* values, subscript 1 refers to a portion of the anti-fingerprint coating without fingerprint oil, and subscript 2 refers to a portion of the anti-fingerprint coating with fingerprint oil. An anti-fingerprint coating can reduce droplet formation, which can increase a visibility and/or color shift of fingerprint oil, by being oleophilic, as defined below. Additionally, the anti-fingerprint coating can enable the removal of aqueous material (e.g., water droplets, sweat droplets) from the coating, for example, by being hydrophobic, as defined below. In further aspects, the anti-fingerprint coating can exhibit an (e.g., as-formed) water contact angle from 90° to 120°, an (e.g., as-formed) oleic acid contact angle of 40° or less, and a coefficient of friction of 0.25 or less. In further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 60° to about 80°, from about 62° to about 75°, from about 65° to about 72°, or any range or subrange therebetween. In aspects, an anti-fingerprint coating can be oleophilic. In aspects, a hexadecane contact angle and/or an oleic acid contact angle of an anti-fingerprint coating (e.g., as-formed) can be about 45° or less, about 40° or less, about 30° or less, about 25° or less, about 20° or less, or the anti-fingerprint coating can wet hexadecane and/or oleic acid. In further aspects, the anti-fingerprint coating (e.g., as formed) wets hexadecane and/or oleic acid. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the anti-fingerprint coating rather than beading up into pronounced droplets.

In aspects, the surface-modifying layer employed as the top coating 140 can be an easy-to-clean coating. Throughout the disclosure, a surface-modifying layer is an “easy-to-clean” coating if the coating on a glass-based substrate can repel material and/or facilitate removal of material disposed thereon relative to the glass-based substrate without the coating. As used herein, an ability to repel material is determined based on a contact angle with higher contact angles associated with greater repulsion. As used herein, an ability to remove material is measured by wiping the material disposed on the surface (e.g., coating or glass-based substrate) with a cheesecloth (see details from the Cheesecloth Abrasion Test with the modification that the material is disposed on the surface before wiping) and the visibility of the material is monitored. A decreased visibility (e.g., fewer wiping cycles to achieve a predetermined reduction is visibility) is associated with a coating facilitating removal of material disposed thereon. In further aspects, the easy-to-clean coating can exhibit an (e.g., as-formed) water contact angle from 90° to 120°, an (e.g., as-formed) oleic acid contact angle of 50° or more, and a coefficient of friction of 0.25 or less. In further aspects, the easy-to-clean coating can be a fluorine-containing material. Alternatively, in further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 60° to about 80°, from about 62° to about 75°, from about 65° to about 72°, or any range or subrange therebetween. In aspects, the anti-fingerprint coating can be oleophilic. In aspects, a hexadecane contact angle of the anti-fingerprint coating (e.g., as-formed) can be about 45° or less, about 40° or less, about 30° or less, about 25° or less, about 20° or less, or the an anti-fingerprint coating can wet hexadecane. In further aspects, the anti-fingerprint coating (e.g., as formed) wets hexadecane. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the surface-modifying layer rather than beading up into pronounced droplets.

The top coating 140 may also include a scratch-resistant layer or layers which comprise any of the materials disclosed as being suitable for use in the scratch-resistant layer 150. In some embodiments, the additional top coating 140 includes a combination of easy-to-clean material and scratch-resistant material. In one example, the combination includes an easy-to-clean material and diamond-like carbon. Such an additional top coating 140 may have a thickness in the range from about 5 nm to about 20 nm. The constituents of the additional coating 140 may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 20 nm or from about 4 nm to about 15 nm (or more specifically about 10 nm) and the second layer of easy-to-clean material may have a thickness of about 1 nm to about 10 nm (or more specifically about 6 nm). The diamond-like coating may include tetrahedral amorphous carbon (Ta—C), Ta—C:H, and/or a-C—H.

According to embodiments of the article 100 depicted in FIGS. 1A-1D, each of the low RI layers 130A and high RI layers 130B of the outer and inner structures 130a, 130b of the optical film structure 120 can have a physical thickness that ranges from about 5 nm to 500 nm, about 5 nm to 250 nm, about 5 nm to 200 nm, and all thicknesses and ranges of thickness between these values. For example, each of these low RI layers 130A and high RI layers 130B can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels. Further, according to embodiments of the article 100 depicted in FIGS. 1A-1D, each of the scratch-resistant layer 150 and medium RI layers 130C of the outer and inner structures 130a, 130b of the optical film structure 120 can have a physical thickness that ranges from about 5 nm to 750 nm, 5 nm to 500 nm, about 5 nm to 250 nm, and all thicknesses and ranges of thickness between these values. For example, each of the medium RI layers 130C (as not employed as a scratch-resistant layer 150) can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels. Further, according to some implementations, each of the low RI layers 130A (e.g., a capping layer 131), medium RI layers 130C and high RI layers 130B of the outer structure 130a can have a physical thickness that ranges from about 5 nm to 250 nm, about 5 nm to 200 nm, about 5 nm to 175 nm, and all thicknesses and ranges of thickness between these values. As an example, each of these layers 130A-130C can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels.

The substrate 110 of the article 100 depicted in FIGS. 1A-1D may include an inorganic material with amorphous and crystalline portions. The substrate 110 may be formed from man-made materials and/or naturally occurring materials (e.g., quartz). In some specific embodiments, the substrate 110 may specifically exclude polymeric, plastic and/or metal substrates. The substrate 110 may be characterized as an alkali-including substrate (i.e., the substrate includes one or more alkalis). In one or more embodiments, the substrate 110 exhibits a refractive index in the range from about 1.5 to about 1.6. In specific embodiments, the substrate 110 (e.g., a strengthened substrate) may exhibit an average strain-to-failure at a surface on one or more opposing primary surfaces 112, 114 that is 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater or even 2% or greater, as measured using an ROR Test using at least 5, at least 10, at least 15, or at least 20 samples to determine the average strain-to-failure value. In specific embodiments, the substrate 110 may exhibit an average strain-to-failure at its surface on one or more opposing primary surfaces 112, 114 of about 1.2%, about 1.4%, about 1.6%, about 1.8%, about 2.2%, about 2.4%, about 2.6%, about 2.8%, or about 3% or greater.

The term “strain-to-failure” refers to the strain at which cracks propagate in the outer or inner structures 130a, 130b of the optical film structure 120, substrate 110, or both simultaneously without application of additional load, typically leading to catastrophic failure in a given material, layer or film and perhaps even bridge to another material, layer, or film, as defined herein. That is, breakage of the optical film structure 120 (i.e., as including outer and/or inner structures 130a, 130b) without breakage of the substrate 110 constitutes failure, and breakage of the substrate 110 also constitutes failure. The term “average” when used in connection with average strain-to-failure or any other property is based on the mathematical average of measurements of such property on 5 samples. Typically, crack onset strain measurements are repeatable under normal laboratory conditions, and the standard deviation of crack onset strain measured in multiple samples may be as little as 0.01% of observed strain. Average strain-to-failure as used herein was measured using an ROR Test. However, unless stated otherwise, strain-to-failure measurements described herein refer to measurements from the ring-on-ring testing, as described in International Publication No. WO2018/125676, published on Jul. 5, 2018, entitled “Coated Articles with Optical Coatings Having Residual Compressive Stress,” and incorporated herein by reference in its entirety.

Suitable substrates 110 may exhibit an elastic modulus (or Young's modulus) in the range from about 60 GPa to about 130 GPa. In some instances, the elastic modulus of the substrate 110 may be in the range from about 70 GPa to about 120 GPa, from about 80 GPa to about 110 GPa, from about 80 GPa to about 100 GPa, from about 80 GPa to about 90 GPa, from about 85 GPa to about 110 GPa, from about 85 GPa to about 105 GPa, from about 85 GPa to about 100 GPa, from about 85 GPa to about 95 GPa, and all ranges and sub-ranges therebetween (e.g., ˜103 GPa). In some implementations, the elastic modulus of the substrate 110 may be greater than 85 GPa, greater than 90 GPa, greater than 95 GPa, or even greater than 100 GPa. In some examples, Young's modulus may be measured by sonic resonance (ASTM E1875), resonant ultrasound spectroscopy, or nanoindentation using Berkovich indenters. Further, suitable substrates 110 may exhibit a shear modulus in the range from about 20 GPa to about 60 GPa, from about 25 GPa to about 55 GPa, from about 30 GPa to about 50 GPa, from about 35 GPa to about 50 GPa, and shear modulus ranges and sub-ranges therebetween (e.g., ˜43 GPa). In some implementations, the substrate 110 may have a shear modulus of greater than 35 GPa, or even greater than 40 GPa. Further, the substrates 110 can exhibit a fracture toughness of greater than 0.8 MPa·√m, greater than 0.9 MPa·√m, greater than 1 MPa·√m, or even greater than 1.1 MPa·√m in some instances (e.g., ˜1.15 MPa·√m).

According to some embodiments, the substrate 110 comprises a glass-ceramic material and can have the following composition: 55-75 mol % SiO₂; 0.2-10 mol % Al₂O₃; 0.2-3 mol % P₂O₅; 0-5 mol % B₂O₃; 15-30 mol % Li₂O; 0-2 mol % Na₂O; 0-2 mol % K₂O; 0-2 mol % MgO; 0-2 mol % ZnO; 0.1-10 mol % ZrO₂; 0-4 mol % TiO₂; 0.01-1.0 mol % SnO₂; and 0-2 mol % Y₂O₃. According to an embodiment, the substrate 110 can consist essentially of the following composition: 68-72 mol % SiO₂; 3-5 mol % Al₂O₃; 0.6-1.2 mol % P₂O₅; 0-5 mol % B₂O₃; 17-25 mol % Li₂O; 0.01-1.7 mol % Na₂O; 0.01-0.5 mol % K₂O; 1.5-3 mol % ZrO₂; 0.01-0.1 mol % SnO₂; 0.01-0.1 mol % HfO₂; and 0.01-0.5 mol % Fe₂O₃ (exemplary glass-ceramic compositions are listed below in Table 1, as measured prior to any ceramming step).

In one or more embodiments, the substrate 110 includes one or more glass-ceramic materials and may be strengthened or non-strengthened. In one or more embodiments, the substrates 110 as a glass-ceramic material may comprise one or more crystalline phases such as lithium disilicate (Li₂Si₂O₅), lithium metasilicate, petalite (LiAlSi₄O₁₀), beta quartz, and/or beta spodumene, as potentially combined with residual glass in the structure. In an embodiment, the substrate 110 comprises a disilicate phase. In another implementation, the substrate 110 comprises a disilicate phase and a petalite phase. According to an embodiment, the substrate 110 has a crystallinity of at least 40% by weight. In some implementations, the substrate 110 has a crystallinity of at least about 40%, 45%, 50%, 55%, 60%, 65%, 70%, 75%, 80%, 85%, or greater (by weight), with the residual as a glass phase. Further, according to some embodiments, each of the crystalline phases of the substrate 110 has an average crystallite size of less than 100 nm, less than 75 nm, less than 50 nm, less than 40 nm, less than 30 nm, and all crystallite sizes within or less than these levels. According to one exemplary embodiment, the substrate 110 comprises lithium disilicate and petalite phases with 40-50 wt. % lithium disilicate (Li₂Si₂O₅), 35-45 wt. % petalite (LiAlSi₄O₁₀), <2 wt. % of other phases, and the remainder as residual glass (e.g., 10-21 wt. % glass) (exemplary phase assemblages are listed below in Table 2). Unless otherwise noted, all phase assemblage amounts and values are measured through X-ray diffraction (XRD) using a Rietveld analysis.

TABLE 1
Exemplary glass-ceramic substrate compositions

| Composition | | | |
|---|---|---|---|
| (mol %) | Ex. A | Ex. B | Ex. C |
| SiO₂ | 70.39 | 70.77 | 68.98 |
| Al₂O₃ | 4.21 | 4.21 | 4.03 |
| P₂O₅ | 0.85 | 0.85 | 1.01 |
| Li₂O | 21.16 | 21.98 | 22.31 |
| Na₂O | 1.50 | 0.06 | 0.07 |
| K₂O | 0.13 | 0.07 | 0.07 |
| ZrO₂ | 1.71 | 2.01 | 2.78 |
| CaO | 0.01 | 0.02 | 0.71 |
| Fe₂O₃ | 0.02 | 0.02 | 0.02 |
| HfO₂ | 0.02 | 0.02 | 0.03 |
| SnO₂ | 0.01 | 0.01 | 0.01 |

TABLE 2
Phase assemblages of exemplary glass-
ceramic substrate compositions (XRD)

| | | lithium disilicate | petalite | |
|---|---|---|---|---|
| | Glass | (Li₂Si₂O₅) | (LiAlSi₄O₁₀) | other phases |
| Material | (wt %) | (wt %) | (wt %) | (wt %) |
| Ex. A | 19 | 43 | 38 | <2% |
| Ex. B | 12 | 45 | 43 | <2% |
| Ex. C | 13 | 44 | 42 | <2% |

According to some embodiments, the substrate 110 comprises a glass material. Examples of suitable glass compositions include soda lime glass composition, an alkali aluminosilicate glass composition, an alkali containing borosilicate glass composition, and an alkali aluminoborosilicate glass composition. In some variants, the glass may be free of lithium.

In other implementations, the substrate 110 may comprise or otherwise consist of a crystalline material, e.g., a single crystal structure, such as sapphire (Al₂O₃). Other suitable materials for a crystalline substrate include polycrystalline alumina layer and/or spinel (MgAl₂O₄). In embodiments, the substrate 110 includes an amorphous base (e.g., glass) and a crystalline cladding (e.g., sapphire layer, a polycrystalline alumina layer and/or or a spinel (MgAl₂O₄) layer).

According to some implementations, the substrate 110 comprises a glass material. Particular example glass compositions suitable to be the substrate 110 comprise SiO₂, B₂O₃ and Na₂O, where (SiO₂+B₂O₃)≥66 mol. %, and Na₂O≥9 mol. %. In an embodiment, the glass composition includes at least 6 wt. % aluminum oxide. In a further embodiment, the substrate 110 includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate 12 can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

Further example glass compositions suitable for the substrate 110 comprise: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

Still further example glass compositions suitable for the substrate 110 comprise: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %

In embodiments, an alkali aluminosilicate glass composition suitable for the substrate 110 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σmodifiers (i.e., sum of modifiers) is greater than 1, where in the ratio the components are expressed in mol. % and the modifiers are alkali metal oxides. This glass composition, in embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σmodifiers (i.e., sum of modifiers) is greater than 1.

In embodiments, the substrate 110 includes an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)−Al₂O₃≤2 mol. %; 2 mol. %≤Na₂O Al₂O₃≤6 mol. %; and 4 mol. %≤(Na₂O+K₂O)−Al₂O₃≤10 mol. %.

According to some implementations, suitable glass compositions for the substrate 110 are listed below in Table 3. Each of the compositions listed in Table 3, Exs. D, E, F, and G are suitable for ion-exchange strengthening.

TABLE 3
Exemplary glass compositions

| Composition | | | | |
|---|---|---|---|---|
| (mol %) | Ex. D | Ex. E | Ex. F | Ex. G |
| SiO₂ | 67.37 | 59.09 | 64.90 | 64.85 |
| B₂O₃ | 3.67 | 4.08 | 3.21 | 3.22 |
| Al₂O₃ | 12.73 | 17.94 | 15.53 | 15.55 |
| P₂O₅ | | 0.66 | 0.86 | 0.86 |
| Li₂O | | 8.00 | 7.20 | 7.21 |
| Na₂O | 13.77 | 8.79 | 4.78 | 4.78 |
| K₂O | 0.010 | 0.07 | 0.21 | 0.21 |
| MgO | 2.39 | 1.23 | 0.54 | 0.54 |
| ZnO | | 0.01 | | |
| TiO₂ | 0.003 | 0.100 | 0.180 | 0.18 |
| ZrO₂ | 0.010 | | 0.010 | 0.01 |
| CaO | | 0.02 | 1.47 | 1.46 |
| Fe₂O₃ | 0.010 | | 0.020 | 0.02 |
| HfO₂ | | | | |
| SnO₂ | 0.09 | 0.04 | 0.04 | 0.04 |
| SrO | | | 1.07 | 1.07 |

Embodiments of the substrate 110 employed in the article 100 of the disclosure (see, e.g., FIGS. 1A-1D) can exhibit a refractive index that is higher than refractive indices of conventional glass substrates or strengthened glass substrates. For example, the refractive index of the substrates 110 can range from about 1.52 to 1.65, from about 1.52 to 1.64, from about 1.52 to 1.62, or from about 1.52 to 1.60, and all refractive indices within the foregoing ranges (e.g., as measured at a visible wavelength of 589 nm). As such, conventional optical coatings, which are typically optimized for glass substrates and their refractive index ranges, are not necessarily suitable for use with substrates 110 as comprising glass-ceramic material of the articles 100 of the disclosure. In particular, the layers of the optical film structure 120 between the substrate 110 and the scratch-resistant layer 150 can be modified to achieve low reflectance and low color generated by the transition zone between the substrate 110 and the scratch-resistant layer 150. This layer re-design requirement can also be described as optical impedance matching between the substrate 110 and the scratch-resistant layer 150.

According to implementations, the substrate 110 is substantially optically clear, transparent and free from light scattering. In such embodiments, the substrate 110 may exhibit an average light transmittance over the optical wavelength regime of about 80% or greater, about 81% or greater, about 82% or greater, about 83% or greater, about 84% or greater, about 85% or greater, about 86% or greater, about 87% or greater, about 88% or greater, about 89% or greater, about 90% or greater, about 91% or greater, about 92% or greater, about 93% or greater, or even about 94% or greater. In some embodiments, these light reflectance and transmittance values may be a total reflectance or total transmittance (taking into account reflectance or transmittance on both primary surfaces 112, 114 of the substrate 110) or may be observed on a single-side of the substrate 110 (i.e., on the primary surface 112 only, without taking into account the opposite surface 114). Unless otherwise specified, the average reflectance or transmittance of the substrate 110 alone is measured at an incident illumination angle of 0 degrees relative to the primary surface 112 (however, such measurements may be provided at incident illumination angles of 45 degrees or 60 degrees).

In some aspects, the substrate 110, in addition to being transparent, can also be colored transparent, opaque, colored opaque, translucent, or colored translucent. As used herein “opaque” and “translucent” can mean as follows: opacity is the measure of impenetrability to visible light. An opaque object is neither transparent (allowing all light to pass through) nor translucent (allowing some light to pass through). When light strikes an interface between two substances, in general some may be reflected, some absorbed, some scattered, and the rest transmitted. An opaque substance transmits very little light, and therefore reflects, scatters, or absorbs most of it. Opacity depends on the frequency of the light being considered. For instance, some kinds of glass, while transparent in the visual range, are largely opaque to ultraviolet light. Further, the colored transparent, colored opaque, and colored translucent can be anyone of a variety of colors including, for example, black, white, green, yellow, pink, red, blue, orange, purple, brown, etc.

Additionally, or alternatively, the physical thickness of the substrate 110 may vary along one or more of its dimensions for aesthetic and/or functional reasons. For example, the edges of the substrate 110 may be thicker as compared to more central regions of the substrate 110. In other implementations, the edges of the substrate 110 may be thinner as compared to more central regions of the substrate 110. According to some embodiments, the substrate 110 is configured as a 2.5D substrate, as comprising a primary surface with a planar portion and at least one nonplanar portion or feature. According to some embodiments, the substrate 110 is configured as a 3D substrate, as comprising two opposing primary surfaces, each primary surface having at least one nonplanar portion or feature. Further, in some embodiments, portions or all of the substrate 110 (e.g., edge portions) may be non-planar (e.g., beveled, chamfered, curved, etc.). The length, width and physical thickness dimensions of the substrate 110 may also vary according to the application or use of the article 100.

The substrate 110 may be provided using a variety of different processes. For instance, where the substrate 110 includes an amorphous portion or phase such as glass, various forming methods can include float glass processes and down-draw processes such as fusion draw and slot draw.

Once formed, a substrate 110 may be strengthened to form a strengthened substrate, e.g., through chemical strengthening by an ion exchange process, thermal tempering, and/or utilizing a mismatch of the coefficient of thermal expansion between portions of the substrate to create compressive stress and central tension regions.

Where the substrate 110 is chemically strengthened by an ion exchange process, the ions in the surface layer of the substrate 110 are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate 110 in a salt bath (or baths), use of multiple salt baths, additional steps such as annealing, washing, and the like, are generally determined by the composition of the substrate 110 and the desired compressive stress (CS), depth of compressive stress layer (or depth of layer) of the substrate 110 that result from the strengthening operation. By way of example, ion exchange of alkali metal-containing substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 530° C., while immersion times range from about 15 minutes up to about 40 hours. However, temperatures and immersion times different from those described above may also be used. In some embodiments, the substrate 110 may be subjected to more than one ion-exchange process. For example, a first ion exchange process can be carried out in a sodium-containing bath, exchanging sodium in the bath for lithium in the glass or substrate 110 to establish a depth of compression (DOC), while subsequently a second ion-exchange process is carried out on the same glass or substrate in a potassium-containing bath to establish a depth of layer of potassium ions (DOL) and further increase the compressive stress in the substrate 110 near the surface.

The degree of chemical strengthening achieved by ion exchange may be quantified based on the parameters of central tension (CT), surface CS, depth of compression (DOC) (i.e., the point in the substrate in which the stress state changes from compression to tension), and depth of layer of potassium ions (DOL). Compressive stress (including surface CS) is measured by a surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass-ceramic material. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Refracted near-field (RNF) method or a scattered light polariscope (SCALP) technique may be used to measure the stress profile. When the RNF method is utilized to measure the stress profile, the maximum CT value provided by SCALP is utilized in the RNF method. In particular, the stress profile measured by RNF is force balanced and calibrated to the maximum CT value provided by a SCALP measurement. The RNF method is described in U.S. Pat. No. 8,854,623, issued Oct. 7, 2014, entitled “Systems and Methods for Measuring a Profile Characteristic of a Glass Sample”, which is incorporated herein by reference in its entirety. In particular, the RNF method includes placing the glass-ceramic article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass-ceramic sample from the normalized detector signal. The maximum CT values are measured using a scattered light polariscope (SCALP) technique known in the art.

In one embodiment of the article 100 (see FIGS. 1A-1D), a strengthened substrate 110 can have a surface CS of 200 MPa or greater, 250 MPa or greater, 300 MPa or greater, or 350 MPa or greater. In another implementation, a strengthened substrate 110 can exhibit a residual surface compressive stress (CS) of from about 200 MPa to about 1200 MPa, from about 200 MPa to about 1000 MPa, from about 200 MPa to about 800 MPa, from about 200 MPa to about 600 MPa, from about 200 MPa to about 500 MPa, from about 200 MPa to about 400 MPa, from about 225 MPa to about 400 MPa, from 250 MPa to about 400 MPa, and all CS sub-ranges and values in the foregoing ranges. The strengthened substrate 110 may have a DOL of from 1 μm to 5 μm, from 1 μm to 10 μm, or from 1 μm to 15 μm and/or a central tension (CT) of 50 MPa or greater, 75 MPa or greater, 100 MPa or greater, 125 MPa or greater (e.g., 80 MPa, 90 MPa, or 100 MPa or greater) but less than 250 MPa (e.g., 200 MPa or less, 175 MPa or less, 150 MPa or less, etc.). In such implementations of the articles 100 with substrates 110 having a CT from about 50 MPa to about 200 MPa or 80 MPa to about 200 MPa, the thickness of the substrate 110 should be limited to about 0.6 mm or less to ensure that the substrate is not frangible. For implementations employing thicker substrates, e.g., with a thickness up to 0.8 mm, 0.9 mm, 1.0 mm, 1.1 mm, 1.2 mm, 1.3 mm, 1.4 mm, or even up to 1.5 mm, the upper limit of CT should be held to levels below 200 MPa to ensure that the substrate is not frangible (e.g., 150 MPa for a thickness of 0.8 mm).

The depth of compression (DOC) of the substrate 110 may be from 0.1·(thickness (t) of the substrate) to about 0.25·t, for example from about 0.15·t to about 0.25·t, or from about 0.15·t to about 0.20·t, and all DOC values between the foregoing ranges. For example, the substrate 110 can have a DOC of 20% of the thickness of the substrate, as compared to 15% or less for ion-exchanged glass substrates. In some implementations, the DOC of the substrate 110 can be from about 5 μm to about 150 μm, from about 5 μm to about 125 μm, from about 5 μm to about 100 μm, and all DOC values between the foregoing ranges. In some embodiments, the depths of compression for the substrate materials can range from ˜8% to ˜20% of the thickness of the substrate 110. Note that the foregoing DOC values are as measured from one of the primary surfaces 112 or 114 of the substrate 110. As such, for a substrate 110 with a thickness of 600 μm, the DOC may be 20% of the thickness of the substrate, ˜120 μm from each of the primary surfaces 112, 114 of the substrate 110, or 240 μm in total for the entire substrate 110. In one or more specific embodiments, the strengthened substrate 110 can exhibit one or more of the following mechanical properties: a surface CS of from about 200 MPa to about 400 MPa, a DOL of greater than 30 μm, a DOC of from about 0.08·t to about 0.25·t, and a CT from about 80 MPa to about 200 MPa.

According to embodiments of the disclosure, the substrate 110 (without the optical film structure 120 disposed thereon for measurement purposes) can exhibit a maximum hardness of 12 GPa or greater, 13 GPa or greater, or 14 GPa or greater (or even greater than 16 GPa in some instances), as measured by a Berkovich Hardness Test over an indentation depth range from 100 nm to about 500 nm in the substrate 110. For example, the substrate 110 can exhibit a maximum hardness of 12 GPa, 12.5 GPa, 13 GPa, 13.5 GPa, 14 GPa, 14.5 GPa, 15 GPa, 15.5 GPa, 16 GPa, and higher hardness levels, as measured by a Berkovich Hardness Test over an indentation depth range from 100 nm to about 500 nm in the substrate 110. Further, substrates 110 of the disclosure can exhibit a Vicker's hardness of greater than 700, or even greater than 800, as measured using a 200 g load. In addition, substrates 110 of the disclosure can exhibit a Mohs hardness of greater than 6.5, or even greater than 7.

As noted earlier, the substrate 110 may be non-strengthened or strengthened, and with a suitable composition to support strengthening. Examples of suitable glass ceramics for the substrate 110 may include a Li₂O—Al₂O₃—SiO₂ system (i.e., an LAS system) glass ceramics, MgO—Al₂O₃—SiO₂ system (i.e., an MAS System) glass ceramics, and/or glass ceramics that include a predominant crystal phase including β-quartz solid solution, β-spodumene ss, cordierite, and lithium disilicate. Such substrates as substrate 110 may be strengthened using the chemical strengthening processes disclosed herein. In one or more embodiments, MAS-System substrates may be strengthened in Li₂SO₄ molten salt, whereby an exchange of 2Li⁺ for Mg²⁺ can occur.

According to some embodiments of the article 100 of the disclosure, the substrate 110 may be a glass-ceramic material of an LAS system with the following composition: 69-80% SiO₂, 5-10% Al₂O₃, 10-15% Li₂O, 0.01-1% Na₂O, 0.01-1% K₂O, 0.1-5% P₂O₅ and 0.1-9% ZrO₂ (in wt. %, oxide basis). In some implementations of the article 100 of the disclosure, the substrate 110 may be an LAS system with the following composition: 69-80% SiO₂, 5-10% Al₂O₃, 10-15% Li₂O, 0.01-1% Na₂O, 0.01-1% K₂O, 0.1-5% P₂O₅ and 0.1-9% ZrO₂ (in wt. %, oxide basis). According to another embodiment, the substrate 110 may be an LAS system with the following composition: 69-75% SiO₂, 5-10% Al₂O₃, 10-15% Li₂O, 0.05-1% Na₂O, 0.1-1% K₂O, 1-5% P₂O₅, 2-9% ZrO₂ and 0.1-2% CaO (in wt. %, oxide basis). According to a further embodiment, the substrate 110 can have the following composition: 69-72% SiO₂, 5-8% Al₂O₃, 10-13% Li₂O, 0.05-0.5% Na₂O, 0.1-0.5% K₂O, 1.5-4% P₂O₅, 4-9% ZrO₂ and 0.5-1.5% CaO (in wt. %, oxide basis). According to some embodiments, the substrate 110 can have the following LAS system composition: 55-75 mol % SiO₂; 0.2-10 mol % Al₂O₃; 0.2-3 mol % P₂O₅; 0-5 mol % B₂O₃; 15-30 mol % Li₂O; 0-2 mol % Na₂O; 0-2 mol % K₂O; 0-2 mol % MgO; 0-2 mol % ZnO; 0.1-10 mol % ZrO₂; 0-4 mol % TiO₂; 0.01-1.0 mol % SnO₂; and 0-2 mol % Y₂O₃. According to an embodiment, the substrate 110 can consist essentially of the following LAS system composition: 68-72 mol % SiO₂; 3-5 mol % Al₂O₃; 0.6-1.2 mol % P₂O₅; 0-5 mol % B₂O₃; 17-25 mol % Li₂O; 0.01-1.7 mol % Na₂O; 0.01-0.5 mol % K₂O; 1.5-3 mol % ZrO₂; 0.01-0.1 mol % SnO₂; 0.01-0.1 mol % HfO₂; and 0.01-0.5 mol % Fe₂O₃. More generally, these compositions of the substrate 110 are advantageous for the articles 100 of the disclosure because they exhibit low haze levels, high transparency, high fracture toughness, and high elastic modulus, and are ion-exchangeable.

According to embodiments of the article 100, the substrates 110 as glass-ceramic materials are selected with any of the compositions of the disclosure and further processed to the crystallinity levels of the disclosure to exhibit a combination of high fracture toughness (e.g., greater than 1 MPa·√m) and high elastic modulus (e.g., greater than 100 GPa). These mechanical properties can be derived from the presence of the crystalline phase (e.g., the lithium disilicate phase), which exhibits a relatively high modulus; and the microstructure of the final substrate 110, which includes some residual glass phase. Notably, the residual glass phase (and its alkali-containing composition) ensures that the substrate 110 can be ion-exchange strengthened to a high level of central tension (CT) (e.g., greater than 80 MPa) and compressive stress (CS) (e.g., greater than 200 MPa). Further, the ceramming (i.e., the post-melt processing, heat treatment conditions) can be chosen to minimize the grain size of the substrate 110 such that the grain size is smaller than the wavelength of visible light, thereby ensuring that the substrate 110 and article 100 is transparent or substantially transparent. Ultimately, the composition and processing of the substrate 110 as comprising a glass-ceramic material is advantageously selected to achieve a balance of high fracture toughness, high clastic modulus and optical transparency to ensure that the article 100, as employing these substrates 110 and an optical film structure 120, exhibits this balance of mechanical and optical properties, along with a surprising level of damage resistance.

The substrate 110 according to one or more embodiments can have a physical thickness ranging from about 100 μm to about 5 mm in various portions of the substrate 110. Example substrate 110 physical thicknesses range from about 100 μm to about 500 μm (e.g., 100, 200, 300, 400 or 500 μm), from about 500 μm to about 1000 μm (e.g., 500, 600, 700, 800, 900 or 1000 μm), and from about 500 μm to about 1500 μm (e.g., 500, 750, 1000, 1250, or 1500 μm), for example. In some implementations, the substrate 110 may have a physical thickness greater than about 1 mm (e.g., about 2, 3, 4, or 5 mm). In one or more specific embodiments, the substrate 110 may have a physical thickness of 2 mm or less, or less than 1 mm. The substrate 110 may be acid polished or otherwise treated to remove or reduce the effect of surface flaws.

With regard to the hardness of the articles 100 depicted in FIGS. 1A-ID, typically, in nanoindentation measurement methods (such as by using a Berkovich indenter) where the coating is harder than the underlying substrate, the measured hardness may appear to increase initially due to development of the plastic zone at shallow indentation depths (e.g., less than 25 nm or less than 50 nm) and then increases and reaches a maximum value or plateau at deeper indentation depths (e.g., from 50 nm to about 500 nm or 900 nm). Thereafter, hardness begins to decrease at even deeper indentation depths due to the effect of the underlying substrate. Where a substrate 110 having a greater hardness compared to the optical film structure 120 is utilized, the same effect can be seen; however, the hardness increases at deeper indentation depths due to the effect of the underlying substrate.

With further regard to the articles 100 depicted in FIGS. 1A-1D, the indentation depth range and the hardness values at certain indentation depth ranges can be selected to identify a particular hardness response of the optical film structure 120 and the layers of the outer and inner structures 130a, 130b thereof, described herein, without the effect of the underlying substrate 110. When measuring hardness of the optical film structure 120 (when disposed on a substrate 110) with a Berkovich indenter, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate 110. The influence of the substrate 110 on hardness occurs at deeper indentation depths (i.e., typically at depths greater than about 10% of the total thickness of the optical film structure 120). Moreover, a further complication is that the hardness response requires a certain minimum load to develop full plasticity during the indentation process. Prior to that certain minimum load, the hardness shows a generally increasing trend.

At small indentation depths (which also may be characterized as small loads) (e.g., up to about 50 nm) in the optical film structure 120, the apparent hardness of a material appears to increase dramatically versus indentation depth. This small indentation depth regime does not represent a true metric of hardness but, instead, reflects the development of the aforementioned plastic zone, which is related to the finite radius of curvature of the indenter. At intermediate indentation depths, the apparent hardness approaches maximum levels. At deeper indentation depths, the influence of the substrate 110 becomes more pronounced as the indentation depths increase. Hardness may begin to drop dramatically once the indentation depth exceeds about 30% of the optical coating thickness.

In one or more embodiments, the article 100, as depicted in FIGS. 1A-1D, may exhibit a maximum hardness that is greater than about 8 GPa, 9 GPa, 10 GPa, 11 GPa, 12 GPa, or greater than 13 GPa (e.g., 13.5 GPa), as measured from the outer surface 120a of the optical film structure 120 by a Berkovich Indenter Hardness Test, which is indicative of high shallow hardness. In one or more embodiments, the article 100, as depicted in FIGS. 1A-1D, may exhibit a hardness that is greater than about 8 GPa, 9 GPa, 10 GPa, 11 GPa, 12 GPa, 12.5 GPa, or greater than 13 GPa (e.g., 13.5 GPa), at an indentation depth of 100 nm, as measured from the outer surface 120a of the optical film structure 120 by a Berkovich Indenter Hardness Test, which is indicative of high shallow hardness.

In one or more embodiments, the article 100, as depicted in FIGS. 1A-1D, may exhibit a maximum hardness that is greater than about 8 GPa, 9 GPa, 10 GPa, 11 GPa, 12 GPa, or greater than 13 GPa (e.g., 13.5 GPa), as measured from the outer surface 120a of the optical film structure 120 at indentation depths from 50 to 900 nm by a Berkovich Indenter Hardness Test. In one or more embodiments, the article 100, as depicted in FIGS. 1A-1D, may exhibit a hardness that is greater than about 8 GPa, 9 GPa, 10 GPa, 11 GPa, 12 GPa, 12.5 GPa, or greater than 13 GPa (e.g., 13.5 GPa), at an indentation depth of 100 nm, as measured from the outer surface 120a of the optical film structure 120 at indentation depths from 50 to 900 nm by a Berkovich Indenter Hardness Test.

In one or more embodiments of the disclosure, the article 100, as depicted in FIGS. 1A-1D with a substrate 110, is expected to exhibit an average failure stress level of 500 MPa or greater, 600 MPa or greater, 700 MPa or greater, 750 MPa or greater, 800 MPa or greater, or even 850 MPa or greater, as measured in an ROR Test with the outer surface 120a of the optical film structure 120 of these articles placed in tension. Essentially, these article-level average failure stress levels are indicative of articles 100 with optical film structures 120 that have not experienced any loss, or have not experienced any substantial loss, in failure strength relative to the strength of their bare substrates. In some embodiments, the article 100 is expected to exhibit an average failure stress level of 500 MPa, 550 MPa, 600 MPa, 650 MPa, 700 MPa, 725 MPa, 750 MPa, 775 MPa, 800 MPa, 825 MPa, 850 MPa, 875 MPa, 900 MPa, 925 MPa, 950 MPa, 975 MPa, 1000 MPa, 1025 MPa, 1050 MPa, 1075 MPa, 1100 MPa, and all average failure stress levels between the foregoing values, as measured in an ROR Test with the outer surface 120a of the optical film structure 120 of the article placed in tension.

Referring again to the articles 100 (see FIGS. 1A-1D) with average ROR failure stress levels of 700 MPa or greater, it should be understood that these failure stress levels can be achieved through the control of the composition, arrangement and/or processing of the optical film structures 120 employed in the articles 100. Notably, the composition, arrangement and/or processing of the optical film structures 120 can be adjusted to obtain residual compressive stress levels of at least 400 MPa (e.g., from 400 to 1200 MPa) and a maximum elastic modulus of at least 140 GPa, as well as a maximum clastic modulus of less than 200 GPa (e.g., from 140 to 200 GPa, from 140 to 170 GPa, or from 140 to 180 GPa). In some cases, it is useful to quantify the elastic modulus of the optical film structure 120 at a depth equal to 15% of the total thickness of the optical film structure 120 to more accurately compare the modulus of the optical film structure 120 for different thicknesses. Using this metric, the preferred range of elastic modulus at a depth equal to 15% of the total thickness of the optical film structure 120 can be adjusted to the range of 140 to 200 GPa, 140 to 180 GPa or 140 to 160 GPa. These mechanical properties of the optical film structures 120 correlate to average failure stress levels of 500 MPa or greater, 600 MPa or greater, or 700 MPa or greater in the articles 100 employing these optical film structures, as measured in an ROR Test with the outer surface 120a of the optical film structure of the article placed in tension.

According to embodiments, the articles 100 depicted in FIGS. 1A-1D may exhibit an average two-sided or two-surface (i.e., through both primary surfaces 112, 114 of the substrate 110) photopic average transmittance, or average visible transmittance, over an optical wavelength regime from 400 to 700 nm, of about 90% or greater, about 91% or greater, about 92% or greater, about 93% or greater, or even about 94% or greater at normal incidence, from 0 to 10 degrees, from 0 to 20 degrees, or even from 0 to 25 degrees. In some embodiments, the articles 100 can exhibit an average two-sided transmittance in the infrared spectrum (e.g., at 940 nm) of about 92% or greater, about 93% or greater, or even about 94% or greater at normal incidence, from 0 to 10 degrees, from 0 to 20 degrees, or even from 0 to 25 degrees.

According to embodiments, the articles 100 depicted in FIGS. 1A-1D may exhibit an average single-sided or first-surface (i.e., through one of the primary surfaces 112, 114 of the substrate 110) photopic reflectance, or average reflectance over an optical wavelength regime from 400 to 700 nm of less than about 2%, less than about 1.5%, less than 1.25%, less than 1.2%, less than 1.1%, less than 1%, less than 0.95%, less than 0.9%, or even less than 0.85%, at normal incidence, near-normal incidence (˜5°, 6°, 7°, or) 8°, or from 0 to 10 degrees, including for all optical film structure thickness factors from 70 to 100%. The articles 100 may exhibit an average single-sided or first-surface (i.e., through one of the primary surfaces 112, 114 of the substrate 110) photopic reflectance, or average reflectance over an optical wavelength regime from 400 to 700 nm of less than about 2%, less than 1.5%, less than 1.25%, less than 1.2%, less than 1.1%, less than 1%, less than 0.95%, or even less than 0.9%, as measured from 0 to 10 degrees, 0 to 20 degrees, 0 to 30 degrees, 5 to 30 degrees, or even 0 to 35 degrees angle of incidence, including for all optical film structure thickness factors from 70 to 100%. Further, the articles 100 depicted in FIGS. 1A-1D may exhibit an average single-sided or first-surface reflectance (i.e., through one of the primary surfaces 112, 114 of the substrate 110) at an infrared wavelength (e.g., at 940 nm) or infrared wavelength range (e.g., 900-950 nm) of less than about 3.5%, less than 3.25%, less than about 3.0%, less than about 2.5%, less than about 2%, less than about 1.5%, or even less than 1%, at normal incidence, near-normal incidence (˜8°), or from 0 to 10 degrees angle of incidence.

According to some implementations, the articles 100 depicted in FIGS. 1A-1D may exhibit a first-surface reflected color with a D65 illuminant from −5 to +5, −4.5 to +4.5, −4 to 32, or −3 to +3 in a* (e.g., −2.2 to +1.2, and −2.2 to +2.5), and −6 to +6, −5 to +5, −4.5 to +4, −4 to +3, or −3.5 to +3, in b* (e.g., −4.2 to +2.6, and −3 to +3), as measured over all incidence angles from 0 to 90 degrees. For example, the articles 100 can exhibit a first-surface reflected color of −4, −3.5, −3.0, −2.5, −2.0, −1.5, −1.0, −0.5, 0, +0.5, +1.0, +1.5, +2.0, +2.5, +3.0, +3.5, +4.0, and all values therebetween, in a*, and −6, −5, −4, −3, −2, −1, 0, +1, +2, +3, +4, and all values therebetween, in b*.

According to some implementations, the articles 100 depicted in FIGS. 1A-1D may exhibit a first-surface (i.e., through one of the primary surfaces 112, 114 of the substrate 110), reflected color with a D65 illuminant, as given by √(a*²+b*²), of less than 10, less than 8.5, less than 8, less than 7, less than 6.5, or even less than 6, as measured at normal incidence, from 0 to 10 degrees, or over all incidence angles from 0 to 90 degrees. For example, the articles 100 can exhibit a reflected color of less than 10, 9, 8.5, 8, 7, 6.5, 6, 5, 4, 3.75, 3.5, 3.25, 3, 2.75, 2.5, 2.25, 2, 1.9, 1.8, 1.7, 1.75, 1.6, 1.5, 1.4, 1.3, 1.25, 1.2, 1.1, 1, or even lower, as measured at normal incidence, from 0 to 10 degrees, or over all incidence angles from 0 to 90 degrees.

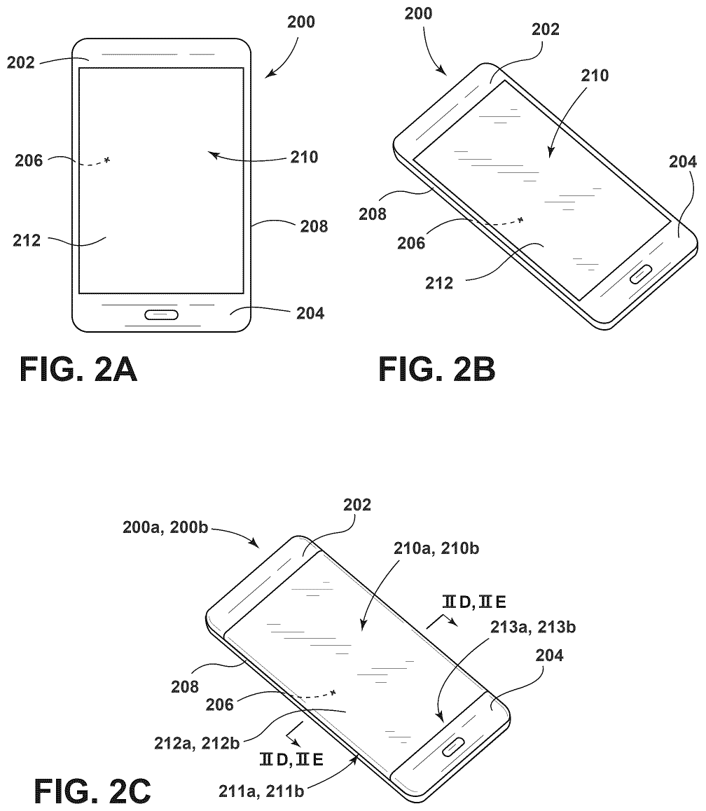

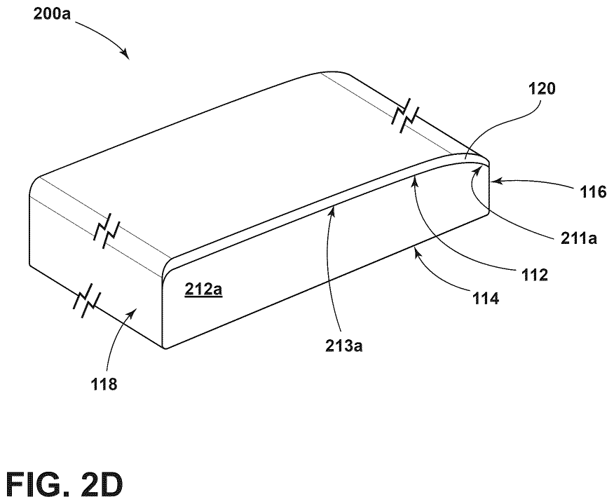

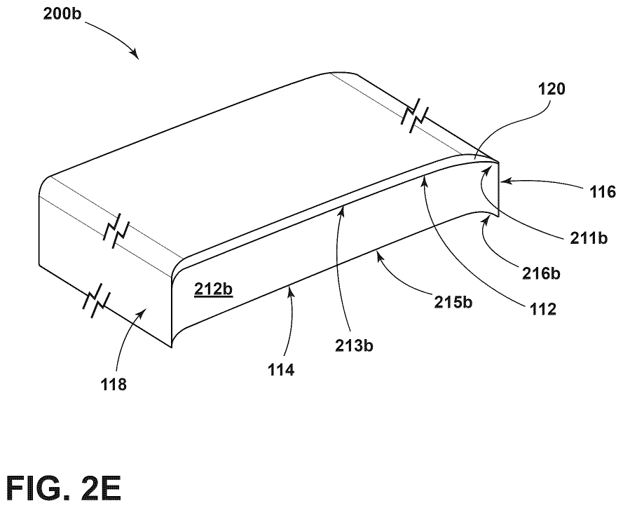

According to some implementations, the articles 100 depicted in FIGS. 1A-1D may exhibit color and reflectance uniformity associated with variations in thickness of the optical film structure 120 that results from line-of-sight layer, film and optical structure deposition methods together with non-planar portions of the substrate 110, e.g., as associated with substrates 110 having flat, angled, or curved regions, 2.5D substrates 110 (see also substrate 212a in FIG. 2D), or 3D substrates 110 (see also substrate 212b in FIG. 2E). In particular, these articles 100 can exhibit a color shift in first-surface reflectance and/or two-surface transmittance, as given by √(a*²+b*²), of less than 10, less than 8, less than 7, less than 6.5, or even less than 6, as measured for optical film structure thickness scaling factors that range from 70 to 100%, 75 to 100%, 80 to 100%, 85 to 100%, 90 to 100%, or 95 to 100%. Further, according to some embodiments, the articles 100 can exhibit a color shift in first-surface reflectance and/or two-surface transmittance, as given by √(a*²+b*²), of less than 15, less than 12.5, less than 10, less than 8, less than 7, less than 6, or even less than 6.5, as measured for optical film structure thickness scaling factors that range from 70 to 100%, 75 to 100%, 80 to 100%, 85 to 100%, 90 to 100%, or 95 to 100%, for all incident angles from 0 to 90 degrees or between two angles of incidence, e.g., where the first angle is selected from the range of 0-20 degrees and the second angle is selected from the range of 45-90 degrees.

Embodiments of the disclosure also include articles 100, as depicted in exemplary form in FIGS. 1A-1D, having a range of part surface angles (part surface curvature) that are combined with an optical film structure 120 in which the structure 120 is designed to be robust to thinning of the film structure that occurs from various coating deposition processes. The net result is an article 100 having a range of part surface curvature angles with an optical film structure 120 having controlled hardness, reflectance, color, and color shift with viewing angle over the entire surface of the article 100, including a portion or all the curved or faceted regions. In addition to absolute levels of hardness, reflectance, and color that meet certain targets, the articles 100 can also exhibit small changes in these values, particularly small changes in visible reflectance and color, when the thickness of the optical film structure 120 is reduced by a scaling factor corresponding to the actual reduction in coating thickness that occurs in an industrially-scalable reactive sputtering process on a manufactured part with surface curvature angles from 0 to 90 degrees. In embodiments, optical film structure thickness scaling factors that range from 70 to 100%, 75 to 100%, 80 to 100%, 85 to 100%, 90 to 100%, or 95 to 100% may correlate to different optical film structure 120 thicknesses created in different regions of an article 100 having a curved or faceted shape with a range of part surface angles from 0 to 10 degrees, 0 to 20 degrees, 0 to 30 degrees, 0 to 40 degrees, 0 to 50 degrees, 0 to 60 degrees, 0 to 70 degrees, 0 to 80 degrees, or 0 to 90 degrees (see FIG. 2C).

An important piece of understanding to create optimal optical film structure designs for an article 100 (see, e.g., FIGS. 2D and 2E) with surface curvature, is an understanding of the coating or layer deposition process used to form the layers of the optical film structure 120, and the level of line-of-sight coating effects that occur in that process. Some coating deposition processes have no line-of-sight behavior at all, such as atomic layer deposition, where one monolayer of molecules or atoms is deposited at a time. However, this process can be slow (at least as limited by current processing technology) and is typically too expensive for applications involving large substrates or industries that are cost sensitive, such as the consumer electronics and automotive industries. A more cost-effective process for forming the optical film structure 120, reactive sputtering, is readily scalable to large areas and can be relatively low cost. However, the nature of industrial reactive sputtering processes generally includes a deposition that has at least some line-of-sight character, meaning that the surfaces of the article directly facing the sputtering targets will receive more deposited material (resulting in a thicker coating), while surfaces of the article tilted at some angle relative to the sputtering targets (e.g., its curved surfaces) will generally receive less material, resulting in a thinner coating.

Accordingly, embodiments of the disclosure include articles 100 (see FIGS. 1A-1D, 2D, and 2E) in which the optical film structure 120 has been optimized with regard to the tradeoffs between hardness, reflectance, color, and number of coating layers. Adding an arbitrary number of layers to achieve an optical target (e.g., without consideration to hardness or other mechanical properties) in the optical coating will tend to reduce the hardness of the coating to levels below the required range for applications targeting scratch-resistant chemically strengthened glass for consumer electronics, automotive, and touch screen applications (e.g., to a hardness<<8 GPa, as measured by Berkovich Indenter Hardness Test at an indentation depth of about 100 nm or greater). In the case of articles 100 having curved surfaces, it can be important to assess how part surface curvature relates to the amount, or scale factor, by which the layers of the optical film structure 120 will be reduced or thinned from their target design thicknesses. The target design thickness (or the thickness at 100% scale factor or 1.0 scale factor) is generally the thickness that is coated on the “flat” areas of the article 100, those portions of the article 100 that are closest to directly facing the sputtering targets, or those portions of the article 100 that receive the most material from the sputtering targets. Any part of the article 100 that is curved away from this maximum thickness deposition direction will generally receive less material, resulting in a thinner coating on these curved areas as each of the layers of the optical film structure 120 is formed. For optimal optical coating design for the optical film structure 120 of embodiments of the articles 100 (see FIGS. 2D and 2E), it can be beneficial to understand the design window in terms of target part curvature, as well as how part curvature corresponds to coating thinning in the deposition process. This can enable optical design of the optical film structure 120 in such a way that optimizes, for example, reflectance and color over the target range of part angles and coating thickness variation, without sacrificing too much in terms of the hardness of the coating, number of layers in the coating, or other metrics. Said another way, without an understanding of the relevant window of part angles and coating thickness scale factors, one can over-design the coating to include too many layers to achieve a desired set of optical properties, thus sacrificing hardness and scratch resistance.

In general, the article 100, as depicted in exemplary form in FIGS. 1A-ID, exhibits an advantageous combination of distinctive structural features, along with mechanical and optical properties, including one or more of the following: an optical film structure 120 that includes at least one low RI layer, one medium RI layer and one high RI layer; an average photopic reflectance of <1.5% at an AOI of 5° for optical film structure thickness factors from 70 to 100%; an average infrared (940 nm) reflectance of <3.5%; a two-surface infrared (940 nm) transmittance of greater than 92%; an optical film structure 120 with a total physical thickness of ≤900 nm; and a maximum hardness for the optical film structure 120 of greater than 8 GPa (and >11 GPa for some embodiments).

The articles 100 disclosed herein (e.g., as shown in FIGS. 1A-1D) may be incorporated into a device article, for example, a device article with a display (or display device articles) (e.g., consumer electronics, including mobile phones, tablets, computers, navigation systems, wearable devices (e.g., watches) and the like), augmented-reality displays, heads-up displays, glasses-based displays, architectural device articles, transportation device articles (e.g., automotive, trains, aircraft, sea craft, etc.), appliance device articles, or any device that benefits from transparency, scratch resistance, abrasion resistance, damage resistance, or a combination thereof. An exemplary device article incorporating any of the articles disclosed herein (e.g., as consistent with the articles 100 depicted in FIGS. 1A-1D) is shown in FIGS. 2A and 2B. Specifically, FIGS. 2A and 2B show a consumer electronic device 200 including a housing 202 having a front 204, a back 206, and side surfaces 208; electrical components (not shown) that are at least partially inside or entirely within the housing and including at least a controller, a memory, and a display 210 at or adjacent to the front surface of the housing; and cover substrate 212 at or over the front surface of the housing such that it is over the display. In some embodiments, the cover substrate 212 may include any of the articles 100 disclosed herein (see, e.g., FIGS. 1A-1D).

Referring now to FIGS. 2C-2E, consumer electronic devices 200a and 200b are depicted, as including a housing 202 having a front 204, a back 206, and side surfaces 208; electrical components (not shown) that are at least partially inside or entirely within the housing and including at least a controller, a memory, and a display 210a, 210b at or adjacent to the front surface of the housing; and cover substrate 212a, 212b at or over the front surface of the housing such that it is over the display. In these embodiments, the cover substrate 212a is a 2.5D substrate and the cover substrate 212b is a 3D substrate, each of which may include any of the optical film structures 120 disclosed herein (see, e.g., FIGS. 1A-1D, 2D and 2E). As also depicted, the cover substrates 212a, 212b include planar portions 213a, 213b, and at least one non-planar feature 211a, 211b on the primary surface 112. Further, cover substrate 212b includes a planar portion 215b and a non-planar feature 216b on the primary surface 114. Further, the displays 210a, 210b of the electronic devices 200a, 200b of FIGS. 2C-2E include a substrate 212a, 212b having at least one non-planar feature and a robust optical film structure 120 that advantageously exhibits the foregoing optical and mechanical properties despite any line-of-sight related thickness variability associated with its non-planar features.

According to an implementation, the article 100 depicted in FIGS. 1A-1D can be prepared according to a process sequence that draws on conventional approaches to substrate processing and optical film structure processing, along with a unique substrate surface preparation approach. In one example, the method includes an initial step of providing the substrate 110. Any of the compositions outlined earlier (see, e.g., Tables 1-3) can be obtained by mixing appropriate precursors, melting them, cooling the melt, and then ceramming the cooled melt (e.g., with a heat treatment to induce some crystallization for a substrate comprising a glass-ceramic or crystalline material) according to process approaches understood by those skilled in the field of the disclosure.

Further, the method of making the article 100 depicted in FIGS. 1A-1D includes a step of disposing an optical film structure 120 on the first primary surface 112 of the substrate 110 after the washing step to define a article comprising the substrate and the optical film structure, the optical film structure having an outer surface and a physical thickness of from about 200 nm to 900 nm. This step can be conducted according to any of the layer deposition approaches (e.g., sputtering) outlined earlier in this disclosure and/or with other approaches as understood by those skilled in the art of the disclosure. Ultimately, the resulting article 100 is as depicted in exemplary form in FIGS. 1A-1D, along with any of the foregoing properties and characteristics detailed in this disclosure.

### EXAMPLES

The following examples describe various features and advantages provided by the disclosure and are in no way intended to limit the invention and appended claims.

### Comparative Example 1

According to this comparative example, an article with a strengthened glass substrate and an optical film structure has been prepared using a conventional processing approach, defined as Comp. Ex. 1 and delineated below in Table 4. The glass substrate is an ion-exchanged substrate with a refractive index of 1.51. Further, the glass substrate employs the Ex. D composition detailed earlier in this disclosure (see Table 3), also referred to as Gorilla® Glass 3 (commercially available from Corning, Inc.). Examples of Gorilla® Glass 3 compositions are described in U.S. Pat. Nos. 7,666,511, 4,483,700, and 5,674,790, the salient contents of which are hereby incorporated by reference in this disclosure.

The layers of the optical film structure of Comp. Ex. 1 were deposited according to vapor deposition conditions set forth in U.S. Patent Application Publication No. 2020/0158916, the salient portions of which are incorporated herein by reference. Notably, this comparative example employs a relatively thick scratch resistant layer comprising high RI material (SiNₓ) having a thickness>150 nm. Further, the optical film structure of this comparative example employs layers having four distinct refractive indices, SiNₓ (n=2.057), SiOₓN_{y} (n=1.744), SiOₓN_{y} (n=1.589), and SiO₂ (n=1.476), which allows for minimizing the amount of low RI material (SiO₂) and minimizing the thickness of the outermost capping layer comprising SiO₂.

TABLE 4
Comp. Ex. 1 article design with strengthened glass substrate

| | | thickness | Index |
|---|---|---|---|
| Layer | Material | (nm) | (550 nm) |
| | Glass | Substrate | 1.51 |
| 1 | SiO₂ | 25 | 1.476 |
| 2 | SiOₓN_{y} | 81.1 | 1.744 |
| 3 | SiNₓ | 65.7 | 2.057 |
| 4 | SiOₓN_{y} | 8.0 | 1.744 |
| 5 | SiNₓ | 158.9 | 2.057 |
| 6 | SiOₓN_{y} | 31.84 | 1.589 |
| 7 | SiO₂ | 65 | 1.476 |
| | Medium | Air | 1 |

| | |
|---|---|
| Total thickness: | 435.5 nm |

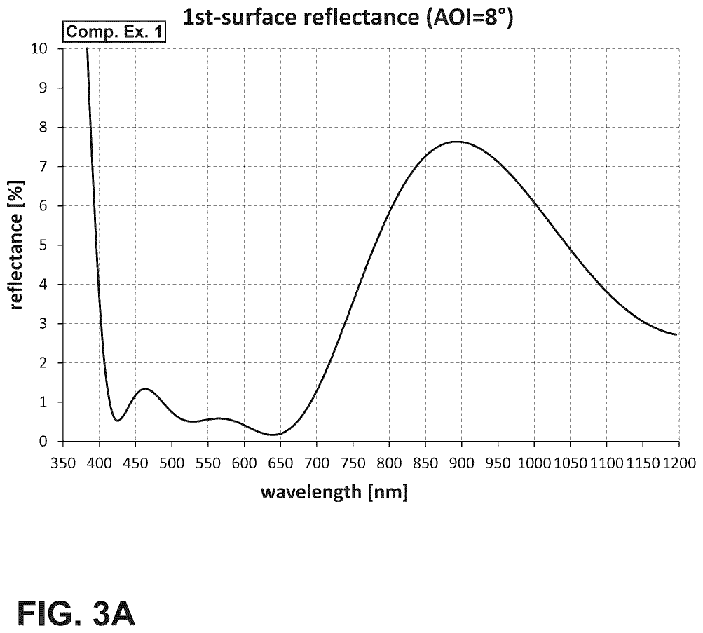

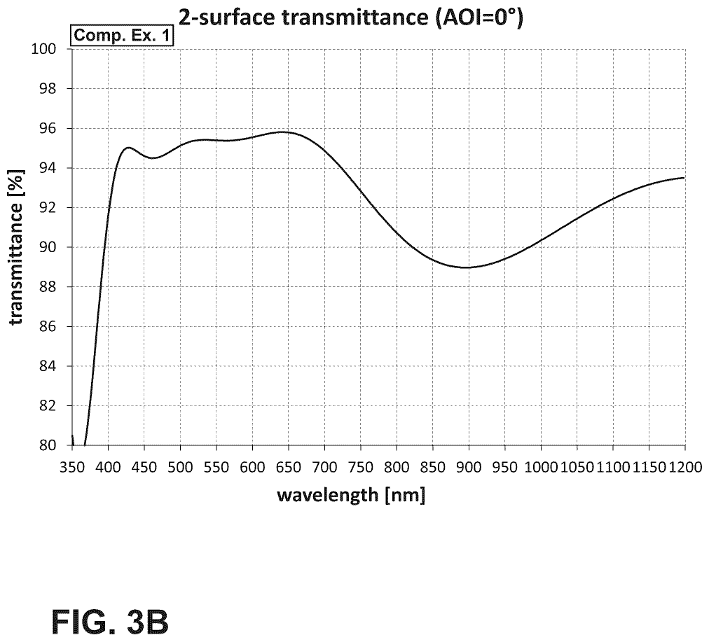

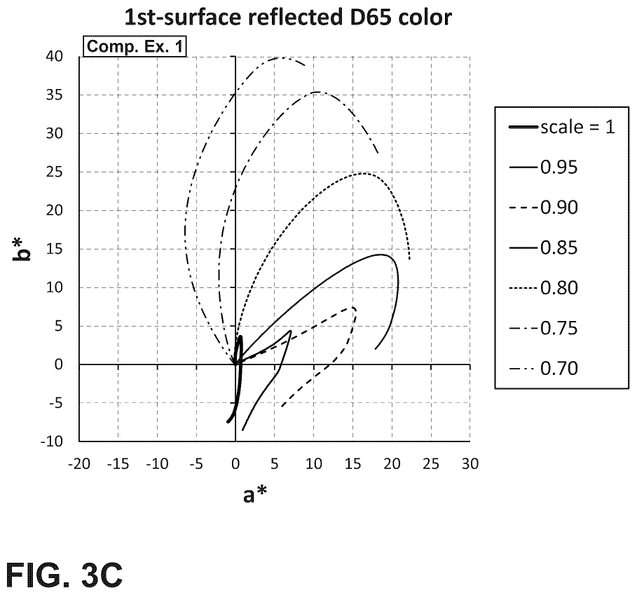

As is evident in the first-surface reflectance data depicted in FIG. 3A, Comp. Ex. 1 exhibits a low reflectance, near 1% or below, in the visible wavelength range (420-700 nm). However, higher reflectance in the infrared (IR) range leads to reduced IR sensor performance, as well as high color on curved substrates due to optical film structure thickness scaling to less than 100% of the design thickness in regions of the substrate that are angled away from the direction of maximum coating deposition rate. For Comp. Ex. 1, the first-surface reflectance at 940 nm is 7.3%.

As is evident in the two-surface transmittance data depicted in FIG. 3B, Comp. Ex. 1 exhibits a high transmittance, near 94% or 95%, in the visible wavelength range (420-700 nm); however, the transmittance is lower in the near-IR wavelength range (750-1000 nm). Importantly, the two-surface transmittance of Comp. Ex. 1 at 940 nm is only 89.3%.

The first-surface reflected D65 color for Comp. Ex. 1 is depicted in FIG. 3C, with each curve representing the full range of illumination angles of incidence from 0 to 90 degrees. The different scaling factors represent different optical film structure thickness scaling factors that may be found on the curved or angled regions of an article due to vacuum deposition line of sight effects associated with deposition of the layers of the optical film structure. For Comp. Ex. 1, the optical film structure color excursions from 0-90 degrees are greater than C*=sqrt(a*\hat{ }2+b*\hat{ }2)=10 for optical film structure thickness scaling factors of 90% or less. Said another way, the color excursions from 0-90 degrees only remain below C*=10 for a small range of optical film structure thickness scaling factors from 95-100%.

Further, Table 4A below illustrates that the first-surface photopic average % reflectance at 5 degree AOI of Comp. Ex. 1 exceeds 1.5% at an optical film structure thickness scaling factor of 80%, and exceeds 4% at a scaling factor of 70%. Further, the first-surface photopic average % reflectance of Comp. Ex. 1 exceeds 2% at 30 degrees AOI, for optical film structure thickness scaling factors of 70-80%.

TABLE 4A
Comp. Ex. 1 reflectance data for various optical film structure factors
1st surface photopic average % Reflectance (Y, D65)

| | Optical Film Structure Thickness Scaling Factor | | | |
|---|---|---|---|---|
| | 1 | 0.9 | 0.8 | 0.7 |
| 5 degree AOI | 0.58 | 0.48 | 1.52 | 4.83 |
| 30 degree AOI | 0.62 | 0.77 | 2.55 | 6.17 |
| 45 degree AOI | 1.29 | 1.89 | 4.63 | 8.27 |
| 60 degree AOI | 4.87 | 6.24 | 10.05 | 13.29 |

### Example 1

According to this inventive example, an article with a strengthened glass substrate and an optical film structure has been prepared using a conventional processing approach, defined as Ex. 1 and delineated below in Table 5. The glass substrate is an ion-exchanged substrate with a refractive index of 1.525. Further, the glass substrate employs the Ex. E composition detailed earlier in this disclosure (see Table 3).

The layers of the optical film structure of Ex. 1 were deposited according to vapor deposition conditions set forth in U.S. Patent Application Publication No. 2020/0158916, the salient portions of which are incorporated herein by reference. Notably, this example may incorporate a surface modifying layer 140 such as a non-fluorine layer or fluorosilane layer 140 on its exterior surface for cleanability or fingerprint hiding. For the purposes of this optical film structure design and modeled optical data, this surface modifying layer is considered to be integral with the top-most air facing SiO₂ layer 131 (capping layer) in the optical film structure stack. The surface modifying layer 140 may also include one or more layers, such as the planarization layer (partial silica matrix) on which there is deposited a fluorine-free ETC, fluorine ETC, or fluorine-free fingerprint-hiding coating per the strategies, as outlined earlier in this disclosure. Further, the surface modifying layer 140 may comprise a fluorine-free silane material, as disclosed in U.S. Published Patent Application No. 2024/0191099, published on Jun. 13, 2024, the salient contents of which are hereby incorporated by reference in this disclosure. The surface modifying layer 140 may also comprise a ‘matrix’ material with high OH or high silanol content, together with a silane-based material, as disclosed in U.S. Published Patent Application No. 2024/0191099, published on Jun. 13, 2024, U.S. Provisional Patent Application Nos. 63/546,775, 63/603,156, and 63/669,001, filed on Nov. 1, 2023, Jul. 5, 2024, and Jul. 7, 2024, respectively, the salient contents of each hereby incorporated by reference in this disclosure.

Ex. 1 was experimentally fabricated, while Exs. 2-4 are based on modeling (see below sections). The fabricated samples of Ex. 1 were measured to have Berkovich nanoindentation hardness of 10-11 GPa at 100 nm indentation depth, hardness of 9.4-9.7 at 500 nm indentation depth, and a maximum hardness of 11.9-12.2 GPa at indentation depths of 160-200 nm.

TABLE 5
Ex. 1 article design with strengthened glass substrate

| | | thickness | Index |
|---|---|---|---|
| Layer | Material | (nm) | (550 nm) |
| | Glass | Substrate | 1.525 |
| 1 | SiO₂ | 51.8 | 1.476 |
| 2 | SiNₓ | 8 | 2.058 |
| 3 | SiO₂ | 66.0 | 1.476 |
| 4 | SiNₓ | 8.0 | 2.058 |
| 5 | SiOₓN_{y} | 75.6 | 1.744 |
| 6 | SiNₓ | 80.4 | 2.058 |
| 7 | SiOₓN_{y} | 15.5 | 1.744 |
| 8 | SiNₓ | 39.7 | 2.058 |
| 9 | SiO₂ | 104.0 | 1.476 |
| | Medium | Air | 1 |

| | |
|---|---|
| Total thickness (nm): | 449.0 |

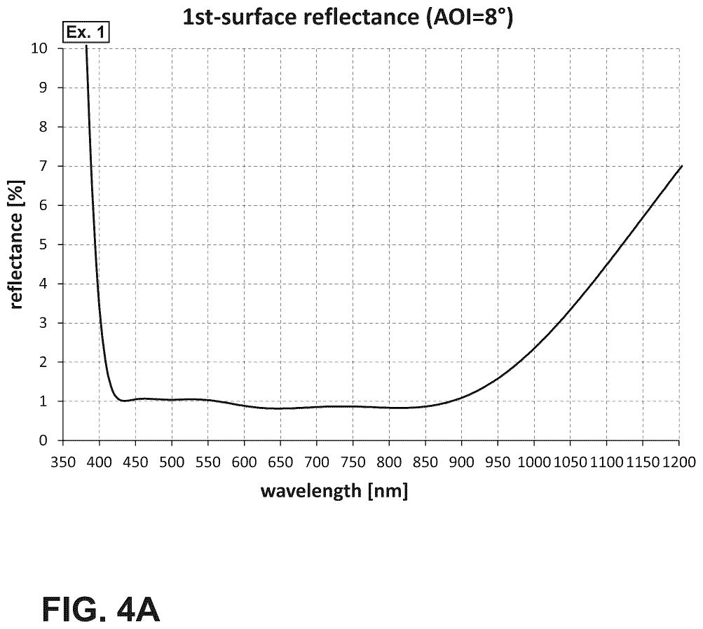

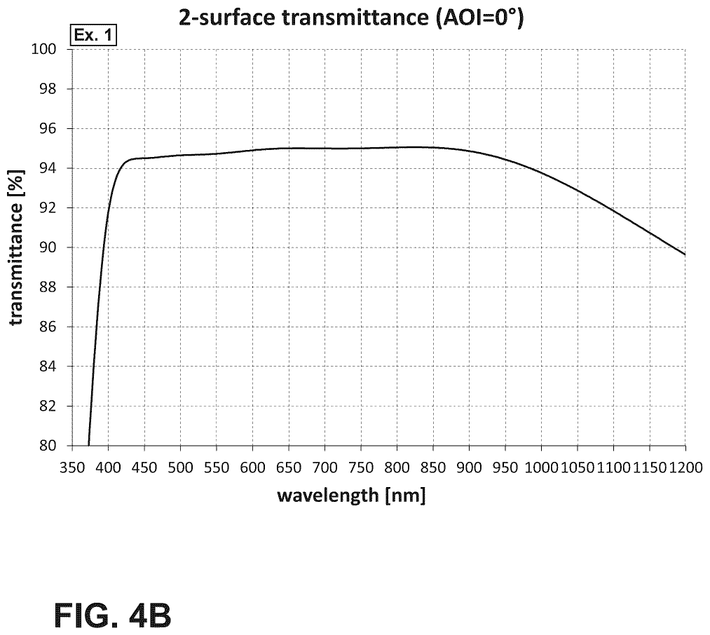

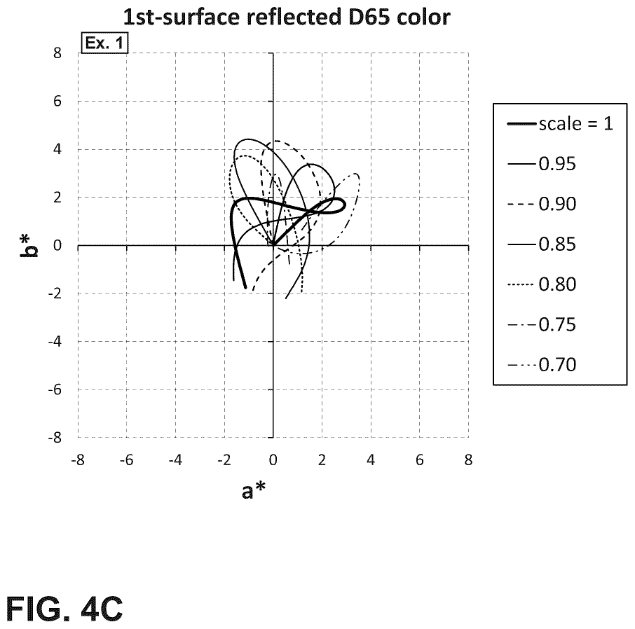

As is evident in the first-surface reflectance data depicted in FIG. 4A, Ex. 1 exhibits a low reflectance, near 1%, in the visible wavelength range (400-700 nm) as well as the near-IR wavelength range (700-1000 nm). Importantly, for Ex. 1, the first-surface reflectance at 940 nm is 1.46%.

As is evident in the two-surface transmittance data depicted in FIG. 4B, Ex. 1 exhibits a high transmittance, near 94% or 95%, in the visible wavelength range (400-700 nm), as well as the near-IR wavelength range (700-1000 nm). Importantly, the two-surface transmittance of Ex. 1 at 940 nm is 94.5%.

The first-surface reflected D65 color for Ex. 1 is depicted in FIG. 4C, with each curve representing the full range of illumination angles of incidence from 0 to 90 degrees. The different scaling factors represent different optical film structure thickness scaling factors that may be found on the curved or angled regions of an article due to vacuum deposition line of sight effects associated with deposition of the layers of the optical film structure. For Ex. 1, the optical film structure color excursions from 0-90 degrees are less than C*=sqrt(a*\hat{ }2+b*\hat{ }2)=5 for optical film structure thickness scaling factors from 70% to 100%. In addition, the color excursions from 0-90 degrees remain within −2<a*<4 and −2.5<b*<4.5 for all optical film structure thickness scaling factors from 70-100%. At 100% scaling (full design thickness), the color excursions from 0-90 degrees remain within −2<a*<3 and −2<b*<2.

Further, Table 5A below illustrates that the first-surface photopic average % reflectance at 5 degree AOI of Ex. 1 remains below 1% for optical film structure thickness scaling factors from 70% to 100%. Further, the first-surface photopic average % reflectance of Ex. 1 remains below 2.2% for all AOI from 5-45°, for optical film structure thickness scaling factors of 70-80%.

TABLE 5A
Ex. 1 reflectance data for various optical film structure factors
1st surface photopic average % Reflectance (Y, D65)

| | Optical Film Structure Thickness Scaling Factor | | | |
|---|---|---|---|---|
| | 1 | 0.9 | 0.8 | 0.7 |
| 5 degree AOI | 0.99 | 0.89 | 0.85 | 0.88 |
| 30 degree AOI | 1.02 | 0.99 | 1.04 | 1.16 |
| 45 degree AOI | 1.61 | 1.72 | 1.90 | 2.15 |
| 60 degree AOI | 4.92 | 5.41 | 5.75 | 6.13 |

### Example 2

According to this inventive example, an article with a strengthened glass substrate and an optical film structure was modeled as being formed using a conventional processing approach, defined as Ex. 2 and delineated below in Table 6. The glass substrate is an ion-exchanged substrate with a refractive index of 1.525. Further, the glass substrate employs the Ex. E composition detailed earlier in this disclosure (see Table 3).

The layers of the optical film structure of Ex. 2 were assumed to be deposited according to vapor deposition conditions set forth in U.S. Patent Application Publication No. 2020/0158916, the salient portions of which are incorporated herein by reference. Notably, this example may incorporate a surface modifying layer 140 such as a non-fluorine layer or fluorosilane layer 140 on its exterior surface for cleanability or fingerprint hiding. For the purposes of this optical film structure design and modeled optical data, this surface modifying layer is considered to be integral with the top-most air facing SiO₂ layer 131 (capping layer) in the optical film structure stack. The surface modifying layer 140 may also include one or more layers, such as the planarization layer (partial silica matrix) on which there is deposited a fluorine-free ETC, fluorine ETC, or fluorine-free fingerprint-hiding coating per the strategies, as outlined earlier in this disclosure. Further, the surface modifying layer 140 may comprise a fluorine-free silane material, as disclosed in U.S. Published Patent Application No. 2024/0191099, published on Jun. 13, 2024, the salient contents of which are hereby incorporated by reference in this disclosure. The surface modifying layer 140 may also comprise a ‘matrix’ material with high OH or high silanol content, together with a silane-based material, as disclosed in U.S. Published Patent Application No. 2024/0191099, published on Jun. 13, 2024, U.S. Provisional Patent Application Nos. 63/546,775, 63/603,156, and 63/669,001, filed on Nov. 1, 2023, Jul. 5, 2024, and Jul. 7, 2024, respectively, the salient contents of each hereby incorporated by reference in this disclosure.

Ex. 2 has an estimated maximum Berkovich nanoindentation hardness of 10-12 GPa at 100 nm indentation depth.

TABLE 6
Ex. 2 article design with strengthened glass substrate

| | | thickness | Index |
|---|---|---|---|
| Layer | Material | (nm) | (550 nm) |
| | Glass | Substrate | 1.525 |
| 1 | SiO₂ | 25.0 | 1.476 |
| 2 | SiOₓN_{y} | 31.0 | 1.744 |
| 3 | SiO₂ | 48.5 | 1.476 |
| 4 | SiNₓ | 20.2 | 2.058 |
| 5 | SiOₓN_{y} | 52.2 | 1.744 |
| 6 | SiNₓ | 102.9 | 2.058 |
| 7 | SiOₓN_{y} | 17.8 | 1.744 |
| 8 | SiNₓ | 28.6 | 2.058 |
| 9 | SiO₂ | 105.8 | 1.476 |
| | Medium | Air | 1 |

| | |
|---|---|
| Total thickness (nm): | 432.0 |

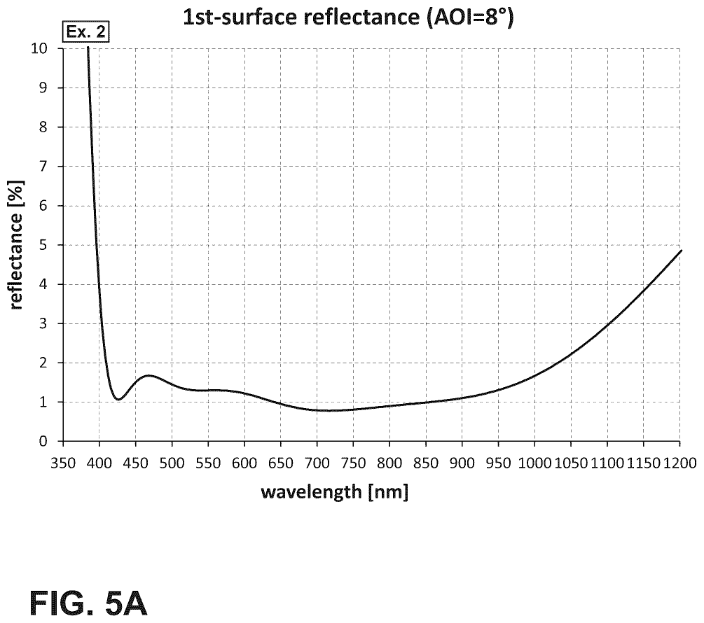

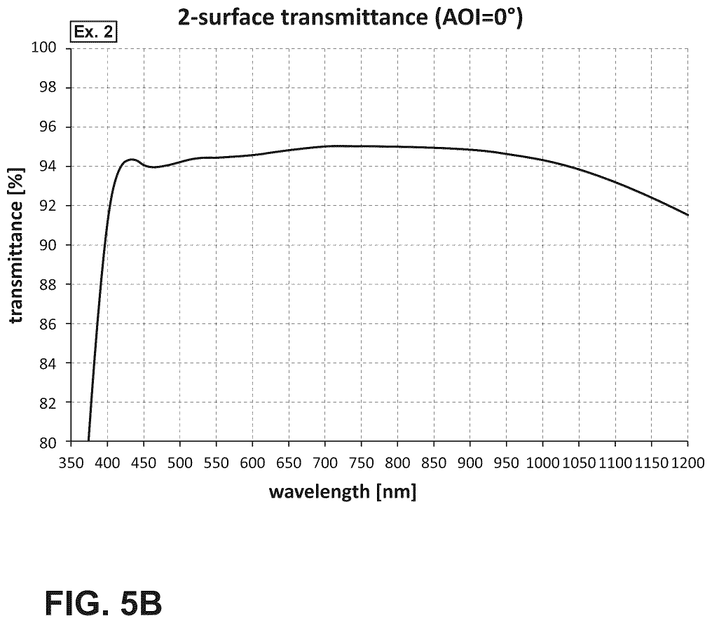

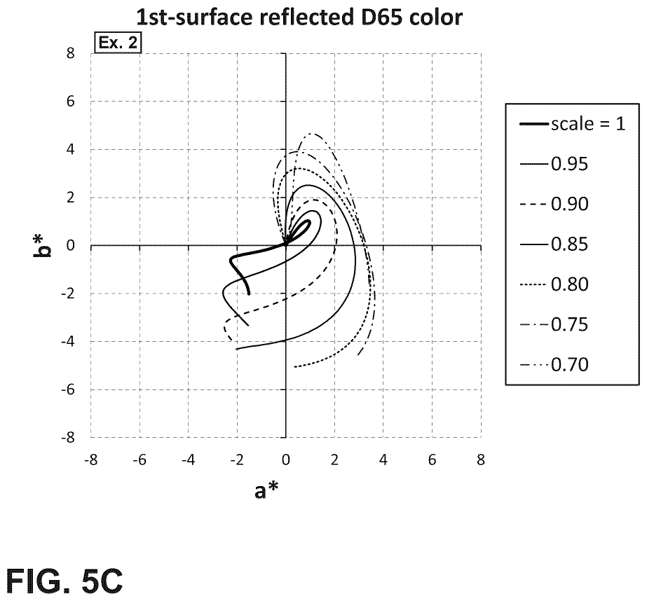

As is evident in the first-surface reflectance data depicted in FIG. 5A, Ex. 2 exhibits a low reflectance, near 1.5% or below, in the visible wavelength range (400-700 nm) as well as the near-IR wavelength range (700-1000 nm). Importantly, for Ex. 2, the first-surface reflectance at 940 nm is 1.25%.

As is evident in the two-surface transmittance data depicted in FIG. 5B, Ex. 2 exhibits a high transmittance, near 94% or 95%, in the visible wavelength range (400-700 nm), as well as the near-IR wavelength range (700-1000 nm). Importantly, the two-surface transmittance of Ex. 2 at 940 nm is 94.7%.

The first-surface reflected D65 color for Ex. 2 is depicted in FIG. 5C, with each curve representing the full range of illumination angles of incidence from 0 to 90 degrees. The different scaling factors represent different optical film structure thickness scaling factors that may be found on the curved or angled regions of an article due to vacuum deposition line of sight effects associated with deposition of the layers of the optical film structure. For Ex. 2, the optical film structure color excursions from 0-90 degrees are less than C*=sqrt(a*\hat{ }2+b*\hat{ }2)=6 for optical film structure thickness scaling factors from 70% to 100%. In addition, the color excursions from 0-90 degrees remain within −2.6<a*<3.8 and −5.2<b*<4.75 for all optical film structure thickness scaling factors from 70-100%. At 100% scaling (full design thickness), the color excursions from 0-90 degrees remain within −2.5<a*<1 and −2.2<b*<1.2.

Further, Table 6A below illustrates that the first-surface photopic average % reflectance at 5-30 degrees AOI of Ex. 2 remains below 1.35% for optical film structure thickness scaling factors from 70% to 100%. Further, the first-surface photopic average % reflectance of Ex. 2 remains below 2.2% for all AOI from 5-45°, for optical film structure thickness scaling factors of 70-100%.

TABLE 6A
Ex. 2 reflectance data for various optical film structure factors
1st surface photopic average % Reflectance (Y, D65)

| | Optical Film Structure Thickness Scaling Factor | | | |
|---|---|---|---|---|
| | 1 | 0.9 | 0.8 | 0.7 |
| 5 degree AOI | 1.31 | 1.12 | 0.90 | 0.91 |
| 30 degree AOI | 1.29 | 1.12 | 1.02 | 1.19 |
| 45 degree AOI | 1.82 | 1.71 | 1.83 | 2.17 |
| 60 degree AOI | 4.99 | 5.17 | 5.64 | 6.11 |

### Example 3

According to this inventive example, an article with a strengthened glass substrate and an optical film structure was modeled as being formed using a conventional processing approach, defined as Ex. 3 and delineated below in Table 7. The glass substrate is an ion-exchanged substrate with a refractive index of 1.507. Further, the glass substrate employs the Ex. D composition detailed earlier in this disclosure (see Table 3).

The layers of the optical film structure of Ex. 3 were assumed to be deposited according to vapor deposition conditions set forth in U.S. Patent Application Publication No. 2020/0158916, the salient portions of which are incorporated herein by reference. Notably, this example may incorporate a surface modifying layer 140 such as a non-fluorine layer or fluorosilane layer 140 on its exterior surface for cleanability or fingerprint hiding. For the purposes of this optical film structure design and modeled optical data, this surface modifying layer is considered to be integral with the top-most air facing SiO₂ layer 131 (capping layer) in the optical film structure stack. The surface modifying layer 140 may also include one or more layers, such as the planarization layer (partial silica matrix) on which there is deposited a fluorine-free ETC, fluorine ETC, or fluorine-free fingerprint-hiding coating per the strategies, as outlined earlier in this disclosure. Further, the surface modifying layer 140 may comprise a fluorine-free silane material, as disclosed in U.S. Published Patent Application No. 2024/0191099, published on Jun. 13, 2024, the salient contents of which are hereby incorporated by reference in this disclosure. The surface modifying layer 140 may also comprise a ‘matrix’ material with high OH or high silanol content, together with a silane-based material, as disclosed in U.S. Published Patent Application No. 2024/0191099, published on Jun. 13, 2024, U.S. Provisional Patent Application Nos. 63/546,775, 63/603,156, and 63/669,001, filed on Nov. 1, 2023, Jul. 5, 2024, and Jul. 7, 2024, respectively, the salient contents of each hereby incorporated by reference in this disclosure.

Ex. 3 has an estimated maximum Berkovich nanoindentation hardness of 9.5 GPa at 100 nm indentation depth.

TABLE 7
Ex. 3 article design with strengthened glass substrate

| | | thickness | Index |
|---|---|---|---|
| Layer | Material | (nm) | (550 nm) |
| | Glass | Substrate | 1.507 |
| 1 | SiO₂ | 25.0 | 1.476 |
| 2 | SiNₓ | 8.9 | 2.058 |
| 3 | SiOₓN_{y} | 66.7 | 1.589 |
| 4 | SiNₓ | 35.6 | 2.058 |
| 5 | SiOₓN_{y} | 40.3 | 1.744 |
| 6 | SiNₓ | 38.1 | 2.058 |
| 7 | SiOₓN_{y} | 30.0 | 1.589 |
| 8 | SiO₂ | 83.1 | 1.476 |
| | Medium | Air | 1 |

| | |
|---|---|
| Total thickness (nm): | 327.7 |

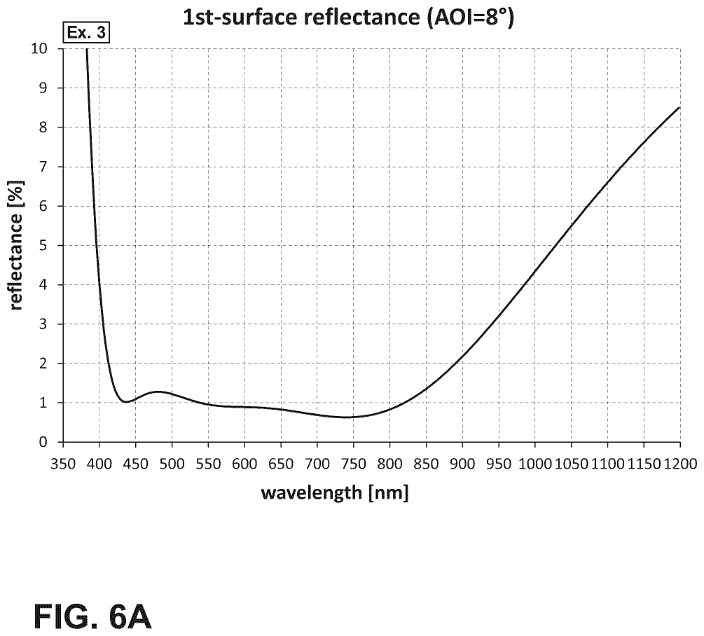

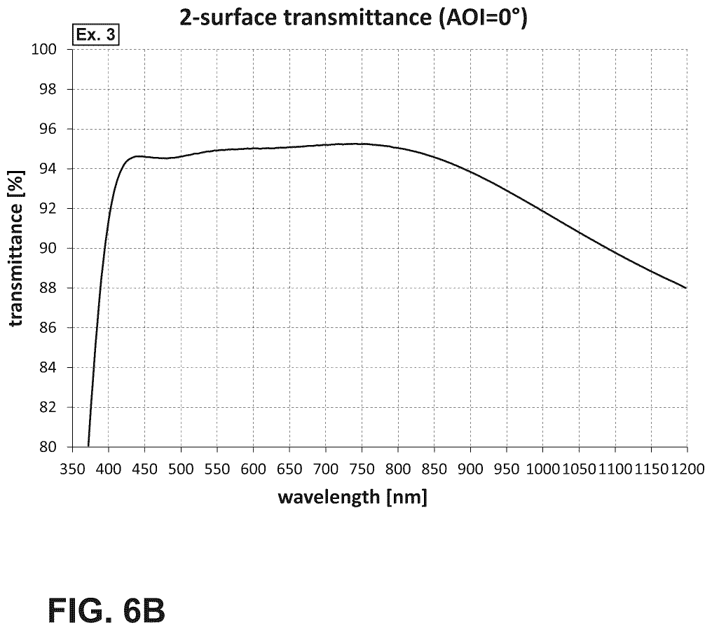

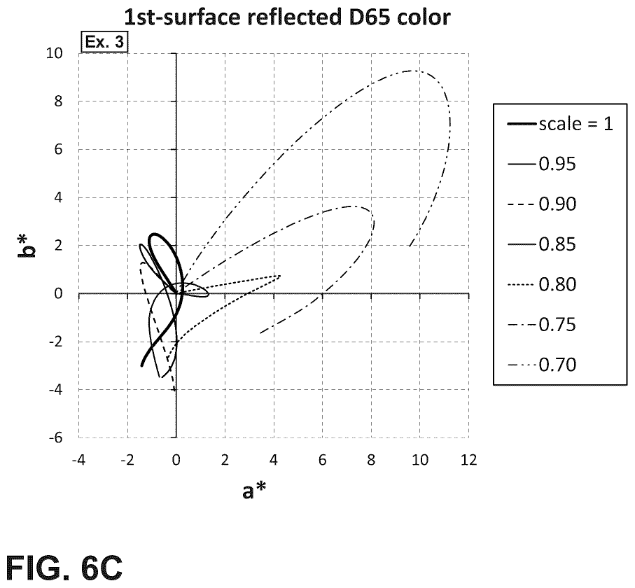

As is evident in the first-surface reflectance data depicted in FIG. 6A, Ex. 3 exhibits a low reflectance, near 1%, in the visible wavelength range (430-700 nm) as well as the near-IR wavelength range (700-850 nm). Importantly, for Ex. 3, the first-surface reflectance at 940 nm is 3.0%.

As is evident in the two-surface transmittance data depicted in FIG. 6B, Ex. 3 exhibits a high transmittance, near 94% or 95%, in the visible wavelength range (430-700 nm), as well as the near-IR wavelength range (700-900 nm). Importantly, the two-surface transmittance of Ex. 3 at 940 nm is 93.1%.

The first-surface reflected D65 color for Ex. 3 is depicted in FIG. 6C, with each curve representing the full range of illumination angles of incidence from 0 to 90 degrees. The different scaling factors represent different optical film structure thickness scaling factors that may be found on the curved or angled regions of an article due to vacuum deposition line of sight effects associated with deposition of the layers of the optical film structure. For Ex. 3, the optical film structure color excursions from 0-90 degrees are less than C*=sqrt(a*\hat{ }2+b*\hat{ }2)=4.5 for optical film structure thickness scaling factors from 80% to 100%. In addition, the color excursions from 0-90 degrees remain within −1.5<a*<4.3 and −4.2<b*<2.5 for all optical film structure thickness scaling factors from 80-100%. At 100% scaling (full design thickness), the color excursions from 0-90 degrees remain within −1.5<a*<0.5 and −3.1<b*<2.5.

Further, Table 7A below illustrates that the first-surface photopic average % reflectance at 5 degrees AOI of Ex. 3 remains below 1.1% for optical film structure thickness scaling factors from 70% to 100%. Further, the first-surface photopic average % reflectance of Ex. 3 remains below 1.75% for all AOI from 5-45°, for optical film structure thickness scaling factors of 80-100%.

TABLE 7A
Ex. 3 reflectance data for various optical film structure factors
1st surface photopic average % Reflectance (Y, D65)

| | Optical Film Structure Thickness Scaling Factor | | | |
|---|---|---|---|---|
| | 1 | 0.9 | 0.8 | 0.7 |
| 5 degree AOI | 1.01 | 0.88 | 0.76 | 0.96 |
| 30 degree AOI | 1.01 | 0.96 | 0.92 | 1.42 |
| 45 degree AOI | 1.65 | 1.65 | 1.72 | 2.70 |
| 60 degree AOI | 5.09 | 5.11 | 5.41 | 7.16 |

### Example 4

According to this inventive example, an article with a strengthened glass substrate and an optical film structure was modeled as being formed using a conventional processing approach, defined as Ex. 4 and delineated below in Table 8. The glass substrate is an ion-exchanged substrate with a refractive index of 1.507. Further, the glass substrate employs the Ex. D composition detailed earlier in this disclosure (see Table 3).

The layers of the optical film structure of Ex. 4 were assumed to be deposited according to vapor deposition conditions set forth in U.S. Patent Application Publication No. 2020/0158916, the salient portions of which are incorporated herein by reference Notably, this example may incorporate a surface modifying layer 140 such as a non-fluorine layer or fluorosilane layer 140 on its exterior surface for cleanability or fingerprint hiding. For the purposes of this optical film structure design and modeled optical data, this surface modifying layer is considered to be integral with the top-most air facing SiO₂ layer 131 (capping layer) in the optical film structure stack. The surface modifying layer 140 may also include one or more layers, such as the planarization layer (partial silica matrix) on which there is deposited a fluorine-free ETC, fluorine ETC, or fluorine-free fingerprint-hiding coating per the strategies, as outlined earlier in this disclosure. Further, the surface modifying layer 140 may comprise a fluorine-free silane material, as disclosed in U.S. Published Patent Application No. 2024/0191099, published on Jun. 13, 2024, the salient contents of which are hereby incorporated by reference in this disclosure. The surface modifying layer 140 may also comprise a ‘matrix’ material with high OH or high silanol content, together with a silane-based material, as disclosed in U.S. Published Patent Application No. 2024/0191099, published on Jun. 13, 2024, U.S. Provisional Patent Application Nos. 63/546,775, 63/603,156, and 63/669,001, filed on Nov. 1, 2023, Jul. 5, 2024, and Jul. 7, 2024, respectively, the salient contents of each hereby incorporated by reference in this disclosure.

Ex. 4 has an estimated maximum Berkovich nanoindentation hardness of 12-13 GPa at 100 nm indentation depth.

TABLE 8
Ex. 4 article design with strengthened glass substrate

| | | thickness | Index |
|---|---|---|---|
| Layer | Material | (nm) | (550 nm) |
| | Glass | Substrate | 1.507 |
| 1 | SiO₂ | 25.0 | 1.476 |
| 2 | SiNₓ | 10.0 | 2.058 |
| 3 | SiO₂ | 59.6 | 1.476 |
| 4 | SiNₓ | 17.2 | 2.058 |
| 5 | SiOₓN_{y} | 58.6 | 1.744 |
| 6 | SiNₓ | 163.8 | 2.058 |
| 7 | SiOₓN_{y} | 39.7 | 1.744 |
| 8 | SiNₓ | 33.7 | 2.058 |
| 9 | SiOₓN_{y} | 43.9 | 1.744 |
| 10 | SiNₓ | 84.6 | 2.058 |
| 11 | SiOₓN_{y} | 12.9 | 1.744 |
| 12 | SiNₓ | 45.9 | 2.058 |
| 13 | SiOₓN_{y} | 30.0 | 1.589 |
| 14 | SiO₂ | 81.0 | 1.476 |
| | Medium | Air | 1 |

| | |
|---|---|
| Total thickness (nm): | 705.9 |

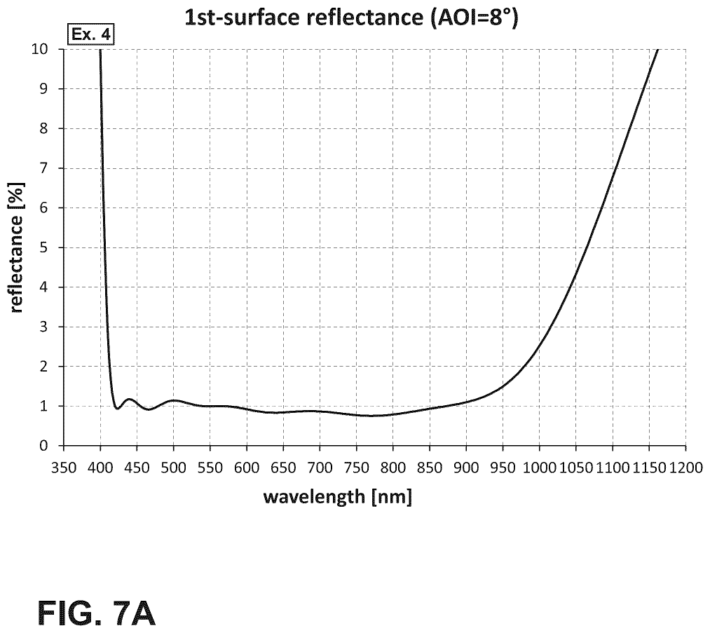

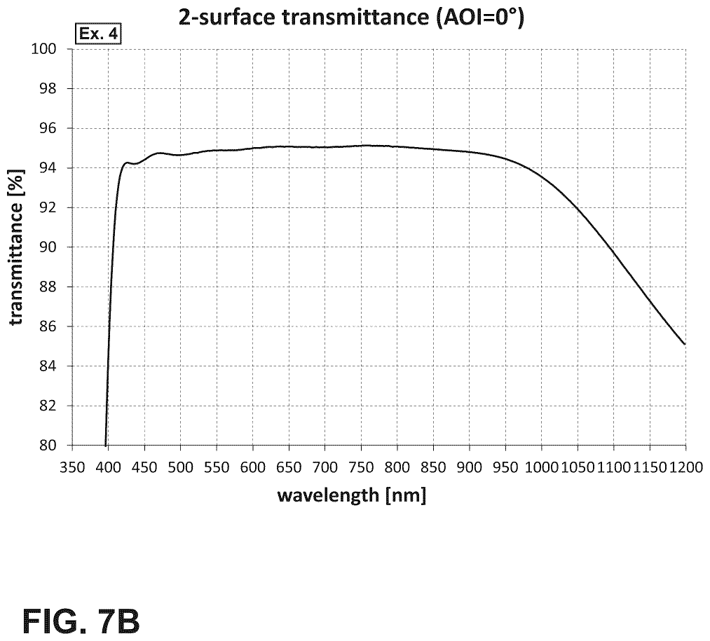

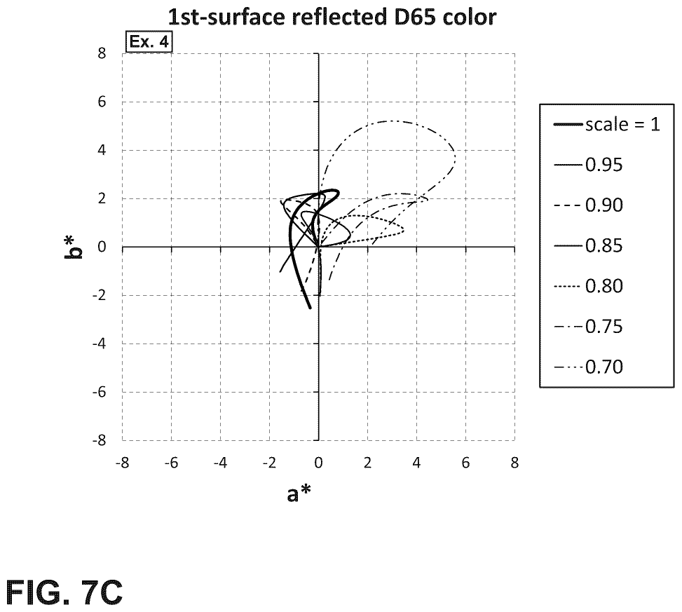

As is evident in the first-surface reflectance data depicted in FIG. 7A, Ex. 4 exhibits a low reflectance, near 1%, in the visible wavelength range (420-700 nm) as well as the near-IR wavelength range (700-950 nm). Importantly, for Ex. 4, the first-surface reflectance at 940 nm is 1.4%.

As is evident in the two-surface transmittance data depicted in FIG. 7B, Ex. 4 exhibits a high transmittance, near 94% or 95%, in the visible wavelength range (420-700 nm), as well as the near-IR wavelength range (700-900 nm). Importantly, the two-surface transmittance of Ex. 4 at 940 nm is 94.5%.

The first-surface reflected D65 color for Ex. 4 is depicted in FIG. 7C, with each curve representing the full range of illumination angles of incidence from 0 to 90 degrees. The different scaling factors represent different optical film structure thickness scaling factors that may be found on the curved or angled regions of an article due to vacuum deposition line of sight effects associated with deposition of the layers of the optical film structure. For Ex. 4, the optical film structure color excursions from 0-90 degrees are less than C*=sqrt(a*\hat{ }2+b*\hat{ }2)=7.0 for optical film structure thickness scaling factors from 70% to 100%. In addition, the color excursions from 0-90 degrees remain within −2<a*<5.6 and −2.7<b*<5.3 for all optical film structure thickness scaling factors from 70-100%. At 100% scaling (full design thickness), the color excursions from 0-90 degrees remain within −1.2<a*<0.9 and −2.6<b*<2.4.

Further, Table 8A below illustrates that the first-surface photopic average % reflectance at 5 degrees AOI of Ex. 4 remains below 1.05% for optical film structure thickness scaling factors from 70% to 100%. Further, the first-surface photopic average % reflectance of Ex. 3 remains below 2.2% for all AOI from 5-45°, for optical film structure thickness scaling factors of 70-100%.

TABLE 8A
Ex. 4 reflectance data for various optical film structure factors
1st surface photopic average % Reflectance (Y, D65)

| | Optical Film Structure Thickness Scaling Factor | | | |
|---|---|---|---|---|
| | 1 | 0.9 | 0.8 | 0.7 |
| 5 degree AOI | 1.00 | 0.91 | 0.85 | 0.86 |
| 30 degree AOI | 1.02 | 1.00 | 1.00 | 1.14 |
| 45 degree AOI | 1.64 | 1.71 | 1.77 | 2.18 |
| 60 degree AOI | 5.08 | 5.22 | 5.42 | 6.47 |

Aspect 1. An article, comprising: a substrate comprising a first primary surface and a second primary surface, the first and second primary surfaces opposing one another; and an optical film structure having an outer surface and a physical thickness of from about 200 nm to 900 nm, the optical film structure disposed on the first primary surface, wherein the optical film structure comprises at least one low refractive index (RI) layer, at least one medium RI layer, and at least one high RI layer, wherein the at least one medium RI layer comprises a refractive index from 1.55 to 1.79, the at least one high RI layer comprises a refractive index of greater than 1.80, and the at least one low RI layer comprises a refractive index from 1.35 to 1.54, wherein the article exhibits a first-surface average photopic reflectance of 2% or less, as measured from 0° to 10° incidence, and further wherein the article exhibits a first-surface reflectance of less than 3.5%, as measured at an infrared wavelength of 940 nm from 0° to 10° incidence.

Aspect 2. The article of Aspect 1, wherein the article exhibits a two-surface transmittance of 92% or greater, as measured at an infrared wavelength of 940 nm from 0° to 10° incidence.

Aspect 3. The article of Aspect 1 or Aspect 2, wherein the article exhibits a first-surface reflected color characterized by International Commission on Illumination (“CIE”) L*, a*, and b* color spaces of −5<a*<+5 and −5<b*<+5.

Aspect 4. The article of any one of Aspects 1-3, wherein the article exhibits a maximum hardness over the range of indentation depths from 50-900 nm of greater than 8 GPa, as measured by a Berkovich Hardness Test at the outer surface of the optical film structure.

Aspect 5. The article of any one of Aspects 1-4, wherein the optical film structure comprises a capping layer defining the outer surface, the capping layer is a low RI layer having a thickness of at least 70 nm, and further wherein the optical film structure comprises directly below the capping layer either a sequence of a high RI layer, medium RI layer, and high RI layer or a sequence of a medium RI layer, high RI layer, and medium RI layer.

Aspect 6. The article of any one of Aspects 1-5, wherein the article exhibits a first-surface average photopic reflectance of 1.25% or less, as measured from 5° to 300 incidence, and further wherein the article exhibits a first-surface reflectance of 2.0% or less, as measured at an infrared wavelength of 940 nm from 0° to 10° incidence.

Aspect 7. The article of any one of Aspects 1-5, wherein article exhibits a first-surface average photopic reflectance of 1.5% or less, as measured from 5° to 30° incidence, and further wherein the article exhibits a first-surface reflectance of 1.5% or less, as measured at an infrared wavelength of 940 nm from 0° to 10° incidence.

Aspect 8. The article of any one of Aspects 1-5, wherein article exhibits a first-surface average photopic reflectance of 1.1% or less, as measured from 5° to 30° incidence, and further wherein the article exhibits a first-surface reflectance of 3.25% or less, as measured at an infrared wavelength of 940 nm from 0° to 10° incidence.

Aspect 9. The article of any one of Aspects 1-5, wherein article exhibits a first-surface average photopic reflectance of 1.2% or less, as measured at 5° incidence, and further wherein the article exhibits a first-surface reflectance of 2% or less, as measured at an infrared wavelength of 940 nm from 0° to 10° incidence.

Aspect 10. The article of any one of Aspects 1-9, wherein the first primary surface comprising a planar portion and a nonplanar portion, and the article exhibits a color shift in first-surface reflectance, as given by √(a*²+b*²), of 10 or less for all optical film structure thickness scaling factors from 80% to 100%, as measured from 0° to 90° incidence.

Aspect 11. The article of any one of Aspects 1-10, wherein the at least one low RI layer comprises SiO₂, the at least one medium RI layer comprises SiOₓN_{y}, and at least one high RI layer comprises SiNₓ.

Aspect 12. The article of any one of Aspects 1-11, wherein the first primary surface comprises a planar portion and a nonplanar portion, and the second primary surface comprises a planar portion and a nonplanar portion.

Aspect 13. A display device, comprising: a housing comprising a front surface, a back surface and side surfaces; electrical components at least partially within the housing, the electrical components comprising a controller, a memory, and a display, the display at or adjacent to the front surface of the housing; and an article disposed over the display, wherein the article is in accordance with any one of Aspects 1-12.

Aspect 14. An article, comprising: a substrate comprising a first primary surface and a second primary surface, the first and second primary surfaces opposing one another, and the first primary surface comprising a planar portion and a nonplanar portion; and an optical film structure having an outer surface and a physical thickness of from about 200 nm to 900 nm, the optical film structure disposed on the first primary surface, wherein the optical film structure comprises at least one low refractive index (RI) layer, at least one medium RI layer, and at least one high RI layer, wherein the at least one medium RI layer comprises a refractive index from 1.55 to 1.79, the at least one high RI layer comprises a refractive index of greater than 1.80, and the at least one low RI layer comprises a refractive index from 1.35 to 1.54, wherein the article exhibits a first-surface average photopic reflectance of less than 1.5% for all optical film structure thickness scaling factors from 70% to 100%, as measured from 0° to 10° incidence, and further wherein the article exhibits a color shift in first-surface reflectance, as given by √(a*²+b*²), of 10 or less for all optical film structure thickness scaling factors from 80% to 100%, as measured from 0° to 900 incidence.

Aspect 15. The article of Aspect 14, wherein the article exhibits a two-surface transmittance of 92% or greater, as measured at an infrared wavelength of 940 nm from 0° to 10° incidence.

Aspect 16. The article of Aspect 14 or Aspect 15, wherein the article exhibits a first-surface reflected color characterized by International Commission on Illumination (“CIE”) L*, a*, and b* color spaces of −5<a*<+5 and −5<b*<+5.

Aspect 17. The article of any one of Aspects 14-16, wherein the article exhibits a maximum hardness over the range of indentation depths from 50-900 nm of greater than 8 GPa, as measured by a Berkovich Hardness Test at the outer surface of the optical film structure.

Aspect 18. The article of any one of Aspects 14-17, wherein the outer structure comprises a capping layer, the capping layer a low RI layer having a thickness of at least 70 nm, and further wherein the optical film structure comprises directly below the capping layer either a sequence of a high RI layer, medium RI layer, and high RI layer or a sequence of a medium RI layer, high RI layer, and medium RI layer.

Aspect 19. The article of any one of Aspects 14-18, wherein the article exhibits a first-surface average photopic reflectance of 1.25% or less for all optical film structure thickness scaling factors from 70% to 100%, as measured from 5° to 30° incidence, and further wherein the article exhibits a color shift in first-surface reflectance, as given by √(a*²+b*²), of 6 or less for all optical film structure thickness scaling factors from 70% to 100% for all incidence angles measured from 0° to 90°.

Aspect 20. The article of any one of Aspects 14-18, wherein article exhibits a first-surface average photopic reflectance of 1.5% or less for all optical film structure thickness scaling factors from 70% to 100%, as measured from 5° to 30° incidence, and further wherein the article exhibits a color shift in first-surface reflectance, as given by √(a*²+b*²), of 8 or less for all optical film structure thickness scaling factors from 70% to 100% for all incidence angles measured from 0° to 90°.

Aspect 21. The article of any one of Aspects 14-18, wherein article exhibits a first-surface average photopic reflectance of 1.1% or less for all optical film structure thickness scaling factors from 70% to 100%, as measured at 5° incidence, and further wherein the article exhibits a color shift in first-surface reflectance, as given by √(a*²+b*²), of 6 or less for all optical film structure thickness scaling factors from 80% to 100% for all incidence angles measured from 0° to 90°.

Aspect 22. The article of any one of Aspects 14-18, wherein article exhibits a first-surface average photopic reflectance of 1.2% or less for all optical film structure thickness scaling factors from 70% to 100%, as measured from 5° to 30° incidence, and further wherein the article exhibits a color shift in first-surface reflectance, as given by √(a*²+b*²), of 8 or less for all optical film structure thickness scaling factors from 70% to 100% for all incidence angles measured from 0° to 90°.

Aspect 23. The article of any one of Aspects 14-22, wherein the at least one low RI layer comprises SiO₂, the at least one medium RI layer comprises SiOₓN_{y}, and at least one high RI layer comprises SiNₓ.

Aspect 24. The article of any one of Aspects 14-23, wherein the second primary surface comprises a planar portion and a nonplanar portion.

Aspect 25. A display device, comprising: a housing comprising a front surface, a back surface and side surfaces; electrical components at least partially within the housing, the electrical components comprising a controller, a memory, and a display, the display at or adjacent to the front surface of the housing; and an article disposed over the display, wherein the article is in accordance with any one of Aspects 14-24.

Aspect 26. An article, comprising: a substrate comprising a first primary surface and a second primary surface, the first and second primary surfaces opposing one another; and an optical film structure having an outer surface and a physical thickness of from about 200 nm to 900 nm, the optical film structure disposed on the first primary surface, wherein the optical film structure comprises at least one low refractive index (RI) layer, at least one medium RI layer, and at least one high RI layer, wherein the at least one medium RI layer comprises a refractive index from 1.55 to 1.79, the at least one high RI layer comprises a refractive index of greater than 1.80, and the at least one low RI layer comprises a refractive index from 1.35 to 1.54, further wherein the outer structure comprises a capping layer, the capping layer a low RI layer having a thickness of at least 70 nm, and wherein the optical film structure comprises directly below the capping layer either a sequence of a high RI layer comprising SiNₓ, medium RI layer comprising SiOₓN_{y}, and high RI layer comprising SiNₓ or a sequence of a medium RI layer comprising SiOₓN_{y}, high RI layer comprising SiNₓ, and medium RI layer comprising SiOₓN_{y}.

Aspect 27. The article of Aspect 26, wherein the optical film structure comprises a five-layer sequence of alternating high RI layers and medium RI layers.

Aspect 28. The article of Aspect 27, wherein one of the high RI layers in the five-layer sequence is a scratch-resistant layer.

Aspect 29. The article of any one of Aspects 26-28, wherein the optical film structure comprises a high RI layer in contact with the capping layer.

Aspect 30. The article of any one of Aspects 26-28, wherein the physical thickness of optical film structure is from 200 nm to 400 nm.

Aspect 31. The article of any one of Aspects 26-28, wherein the physical thickness of optical film structure is from 500 nm to 800 nm.

Aspect 32. The article of any one of Aspects 26-31, wherein the optical film structure comprises at least 8 layers.

Aspect 33. The article of any one of Aspects 26-32, wherein a total thickness of the low RI layers in the optical film structure having a refractive index from 1.35 to 1.54 is at least 80 nm.

Aspect 34. The article of any one of Aspects 26-33, wherein a total thickness of the low RI layers in the optical film structure having a refractive index from 1.35 to 1.54 over the physical thickness of the optical film structure is at least 20%.

Aspect 35. The article of any one of Aspects 26-34, wherein article exhibits a first-surface average photopic reflectance of 1.25% or less for all optical film structure thickness scaling factors from 70% to 100%, as measured from 5° to 30° incidence, and further wherein the article exhibits a color shift in first-surface reflectance, as given by √(a*²+b*²), of 6 or less for all optical film structure thickness scaling factors from 70% to 100% for all incidence angles measured from 0° to 90°.

Aspect 36. The article of any one of Aspects 26-34, wherein article exhibits a first-surface average photopic reflectance of 1.5% or less for all optical film structure thickness scaling factors from 70% to 100%, as measured from 5° to 30° incidence, and further wherein the article exhibits a color shift in first-surface reflectance, as given by √(a*²+b*²), of 8 or less for all optical film structure thickness scaling factors from 70% to 100% for all incidence angles measured from 0° to 90°.

Aspect 37. The article of any one of Aspects 26-34, wherein article exhibits a first-surface average photopic reflectance of 1.1% or less for all optical film structure thickness scaling factors from 70% to 100%, as measured at 5° incidence, and further wherein the article exhibits a color shift in first-surface reflectance, as given by √(a*²+b*²), of 6 or less for all optical film structure thickness scaling factors from 80% to 100% for all incidence angles measured from 0° to 90°.

Aspect 38. The article of any one of Aspects 26-34, wherein article exhibits a first-surface average photopic reflectance of 1.2% or less for all optical film structure thickness scaling factors from 70% to 100%, as measured from 5° to 30° incidence, and further wherein the article exhibits a color shift in first-surface reflectance, as given by √(a*²+b*²), of 8 or less for all optical film structure thickness scaling factors from 70% to 100% for all incidence angles measured from 0° to 90°.

Aspect 39. The article of any one of Aspects 26-38, wherein the first primary surface comprising a planar portion and a nonplanar portion, and the article exhibits a color shift in first-surface reflectance, as given by √(a*²+b*²), of 10 or less for all optical film structure thickness scaling factors from 80% to 100%, as measured from 0° to 90° incidence.

Aspect 40. The article of any one of Aspects 26-39, wherein the optical film structure further comprises a scratch-resistant layer, an outer structure, and an inner structure, the scratch-resistant layer disposed between the outer and inner structures, the inner structure disposed on the first primary surface, the outer structure comprising at least one medium RI layer and at least one low RI layer, and the inner structure comprising at least one set of alternating high and low RI layers, and further wherein scratch-resistant layer is the thickest high index layer in the optical film structure.

Aspect 41. The article of any one of Aspects 26-39, wherein the first primary surface comprises a planar portion and a nonplanar portion, and the second primary surface comprises a planar portion and a nonplanar portion.

Aspect 42. A display device, comprising: a housing comprising a front surface, a back surface and side surfaces; electrical components at least partially within the housing, the electrical components comprising a controller, a memory, and a display, the display at or adjacent to the front surface of the housing; and an article disposed over the display, wherein the article is in accordance with any one of Aspects 26-42.

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that has been set forth and defined within the following aspects.

What is claimed is:

1. An article, comprising:
a substrate comprising a first primary surface and a second primary surface, the first and second primary surfaces opposing one another; and
an optical film structure having an outer surface and a physical thickness of from about 200 nm to 900 nm, the optical film structure disposed on the first primary surface,
wherein the optical film structure comprises at least one low refractive index (RI) layer, at least one medium RI layer, and at least one high RI layer,
wherein the at least one medium RI layer comprises a refractive index from 1.55 to 1.79, the at least one high RI layer comprises a refractive index of greater than 1.80, and the at least one low RI layer comprises a refractive index from 1.35 to 1.54,
wherein the article exhibits a first-surface average photopic reflectance of 2% or less, as measured from 0° to 10° incidence, and
further wherein the article exhibits a first-surface reflectance of less than 3.5%, as measured at an infrared wavelength of 940 nm from 0° to 10° incidence.

2. The article of claim 1, wherein:
the article exhibits a two-surface transmittance of 92% or greater, as measured at an infrared wavelength of 940 nm from 0° to 10° incidence; and
the article exhibits a first-surface reflected color characterized by International Commission on Illumination (“CIE”) L*, a*, and b* color spaces of −5<a*<+5 and −5<b*<+5.

3. The article of claim 1, wherein the article exhibits a maximum hardness over the range of indentation depths from 50-900 nm of greater than 8 GPa, as measured by a Berkovich Hardness Test at the outer surface of the optical film structure.

4. The article of claim 1, wherein the optical film structure comprises a capping layer defining the outer surface, the capping layer is a low RI layer having a thickness of at least 70 nm, and further wherein the optical film structure comprises directly below the capping layer either a sequence of a high RI layer, medium RI layer, and high RI layer or a sequence of a medium RI layer, high RI layer, and medium RI layer.

5. The article of claim 1, wherein the article exhibits a first-surface average photopic reflectance of 1.25% or less, as measured from 5° to 30° incidence, and further wherein the article exhibits a first-surface reflectance of 2.0% or less, as measured at an infrared wavelength of 940 nm from 0° to 10° incidence.

6. The article of claim 1, wherein the first primary surface comprising a planar portion and a nonplanar portion, and the article exhibits a color shift in first-surface reflectance, as given by √(a*²+b*²), of 10 or less for all optical film structure thickness scaling factors from 80% to 100%, as measured from 0° to 90° incidence.

7. The article of claim 1, wherein the at least one low RI layer comprises SiO₂, the at least one medium RI layer comprises SiOₓN_{y}, and at least one high RI layer comprises SiNₓ.

8. The article of claim 1, wherein the first primary surface comprises a planar portion and a nonplanar portion, and the second primary surface comprises a planar portion and a nonplanar portion.

9. An article, comprising:
a substrate comprising a first primary surface and a second primary surface, the first and second primary surfaces opposing one another, and the first primary surface comprising a planar portion and a nonplanar portion; and
an optical film structure having an outer surface and a physical thickness of from about 200 nm to 900 nm, the optical film structure disposed on the first primary surface,
wherein the optical film structure comprises at least one low refractive index (RI) layer, at least one medium RI layer, and at least one high RI layer,
wherein the at least one medium RI layer comprises a refractive index from 1.55 to 1.79, the at least one high RI layer comprises a refractive index of greater than 1.80, and the at least one low RI layer comprises a refractive index from 1.35 to 1.54,
wherein the article exhibits a first-surface average photopic reflectance of less than 1.5% for all optical film structure thickness scaling factors from 70% to 100%, as measured from 0° to 10° incidence, and
further wherein the article exhibits a color shift in first-surface reflectance, as given by √(a*²+b*²), of 10 or less for all optical film structure thickness scaling factors from 80% to 100%, as measured from 0° to 90° incidence.

10. The article of claim 9, wherein:
the article exhibits a two-surface transmittance of 92% or greater, as measured at an infrared wavelength of 940 nm from 0° to 10° incidence; and
the article exhibits a first-surface reflected color characterized by International Commission on Illumination (“CIE”) L*, a*, and b* color spaces of −5<a*<+5 and −5<b*<+5.

11. The article of claim 9, wherein the article exhibits a maximum hardness over the range of indentation depths from 50-900 nm of greater than 8 GPa, as measured by a Berkovich Hardness Test at the outer surface of the optical film structure.

12. The article of claim 9, wherein the outer structure comprises a capping layer, the capping layer a low RI layer having a thickness of at least 70 nm, and further wherein the optical film structure comprises directly below the capping layer either a sequence of a high RI layer, medium RI layer, and high RI layer or a sequence of a medium RI layer, high RI layer, and medium RI layer,

13. The article of claim 9, wherein the article exhibits a first-surface average photopic reflectance of 1.25% or less for all optical film structure thickness scaling factors from 70% to 100%, as measured from 5° to 30° incidence, and further wherein the article exhibits a color shift in first-surface reflectance, as given by √(a*²+b*²), of 6 or less for all optical film structure thickness scaling factors from 70% to 100% for all incidence angles measured from 0° to 90°.

14. The article of claim 9, wherein the at least one low RI layer comprises SiO₂, the at least one medium RI layer comprises SiOₓN_{y}, and at least one high RI layer comprises SiNₓ.

15. The article of claim 9, wherein the second primary surface comprises a planar portion and a nonplanar portion.

16. An article, comprising:
a substrate comprising a first primary surface and a second primary surface, the first and second primary surfaces opposing one another; and
an optical film structure having an outer surface and a physical thickness of from about 200 nm to 900 nm, the optical film structure disposed on the first primary surface,
wherein the optical film structure comprises at least one low refractive index (RI) layer, at least one medium RI layer, and at least one high RI layer,
wherein the at least one medium RI layer comprises a refractive index from 1.55 to 1.79, the at least one high RI layer comprises a refractive index of greater than 1.80, and the at least one low RI layer comprises a refractive index from 1.35 to 1.54,
further wherein the outer structure comprises a capping layer, the capping layer a low RI layer having a thickness of at least 70 nm, and
wherein the optical film structure comprises directly below the capping layer either a sequence of a high RI layer comprising SiNₓ, medium RI layer comprising SiOₓN_{y}, and high RI layer comprising SiNₓ or a sequence of a medium RI layer comprising SiOₓN_{y}, high RI layer comprising SiNₓ, and medium RI layer comprising SiOₓN_{y}.

17. The article of claim 16, wherein a total thickness of the low RI layers in the optical film structure having a refractive index from 1.35 to 1.54 is at least 80 nm.

18. The article of claim 16, wherein the optical film structure further comprises a scratch-resistant layer, an outer structure, and an inner structure, the scratch-resistant layer disposed between the outer and inner structures, the inner structure disposed on the first primary surface, the outer structure comprising at least one medium RI layer and at least one low RI layer, and the inner structure comprising at least one set of alternating high and low RI layers, and further wherein scratch-resistant layer is the thickest high index layer in the optical film structure.

19. The article of claim 16, wherein the optical film structure comprises a high RI layer in contact with the capping layer.

20. The article of claim 16, wherein the first primary surface comprises a planar portion and a nonplanar portion, and the second primary surface comprises a planar portion and a nonplanar portion.
